(19) United States
(12) Patent Application Publication
(10) Pub. No.: US 2026/0283887 A1
(43) Pub. Date: Sep. 24, 2026

(54) TIP FOR CHIROPRACTIC ADJUSTING INSTRUMENT SYSTEM AND METHOD

(71) Applicant: Activator Methods International, Ltd., Phoenix, AZ (US)

(72) Inventors: Arlan W. Fuhr, Phoenix, AZ (US); Michael Liebschner, Pearland, TX (US)

(73) Assignee: Activator Methods International, Ltd., Phoenix, AZ (US)

(21) Appl. No.: 19/574,095

(22) Filed: Mar. 20, 2026

Related U.S. Application Data
(60) Provisional application No. 63/775,427, filed on Mar. 21, 2025.

(51) Int. Cl. A61H 1/00; A61H 23/00; A61H 23/02

(52) U.S. Cl. CPC A61H 1/008; A61H 23/008; A61H 23/02; A61H 2201/0107; A61H 2201/018; A61H 2201/169

(57) ABSTRACT

A nose piece/tip portion for use with a chiropractic adjusting instrument to apply a desired impulse force to tissues of a geriatric and/or pediatric patient. The nose piece/tip includes an elongate body defining a first internal cavity in communication with a distal end of a thrust rod, and a second internal infill cavity positioned between the distal end of the first internal cavity and the distal end of the elongate body. An infill member having a select micro-architecture is mounted within the second internal infill cavity to adjust the volume fraction of a front portion of the elongate body.

### CROSS-REFERENCE TO RELATED APPLICATIONS

This application claims priority to and the benefit of U.S. Provisional Patent Application No. 63/775,427 filed Mar. 21, 2025, entitled “TIP FOR CHIROPRACTIC ADJUSTING INSTRUMENT SYSTEM AND METHOD,” the disclosure of which is incorporated herein by reference in its entirety for all purposes.

### INCORPORATION BY REFERENCE

The disclosures of U.S. patent application Ser. No. 18/413,997, filed Jan. 16, 2024, now U.S. Pat. No. 11,911,329, U.S. patent application Ser. No. 16/647,738, filed Mar. 16, 2020, International Application No. PCT/US2018/051438, filed Sep. 18, 2018, and U.S. Provisional Patent Application No. 62/559,806, filed Sep. 18, 2017, are hereby incorporated by reference for all purposes as if presented herein in their entirety.

### FIELD

The present invention relates generally to a portable chiropractic instrument for use in chiropractic adjustment of musculoskeletal structures. More particularly, the invention relates to a resilient nose piece/tip for a power operated chiropractic adjusting instrument system and method for using same in spinal manipulative therapy to apply desired impact forces or thrusts to a human body.

### BACKGROUND

The chiropractic art is generally concerned with adjusting misaligned body structures by manually manipulating the various joints in the human body. Of more specific interest in the art, however, is the spinal column which is comprised of a plurality of interconnected musculoskeletal structures or vertebrae. The human spine is susceptible to many different pathologic abnormalities including misalignment, miscellaneous trauma and pain, and degeneration as a result of age or disease. By employing various chiropractic techniques, though, a chiropractor, or one skilled in the chiropractic art, may be able to successfully treat a physiologically abnormal spine. Such treatment often results in immediate relief of pain or discomfort that the patient might be suffering and can improve the overall quality of life of that patient.

Conventional spinal-adjustment techniques can involve the selective application of thrusts or forces to the afflicted and targeted region of the spine. Such conventional spinal-adjustment techniques can include “mobilizing” the spine (i.e., passively moving the spine with relatively slow cyclic or oscillatory motion), or “manipulating” the spine (i.e., applying an impulsive thrust or force in a well-defined direction to a specific region of the spine). Depending on professional affiliations, these techniques are referred to as chiropractic adjustment, osteopathic manipulation, orthopedic manual therapy, and/or spinal manipulative therapy. It is appreciated that such mechanical shockwave therapy is widely used in chiropractic practice.

It is known in the art that a shockwave differs from an acoustic wave in that an acoustic wave generally consists of periodic oscillation whereas a shockwave is a single pulse. In operation, the shockwave applied in a chiropractic context is a mechanical pressure pulse that expands as a half-sine wave within the human body. Further, the applied shockwave's propagation capabilities and tissue penetration depth depends on the energy of the shockwave and on the tissue damping effect. Viscoelastic damping of the shockwave is minimized at or around the natural frequency of the tissue. It is contemplated that high transmissibility can be achieved at tissue resonance while concurrently reducing the energy requirement of the shockwave generator and diminishing side effects caused by the overstimulation of surrounding tissue. The shockwave is applied to the patient via a resilient tip that should be designed to enhance the safety and efficacy of healthcare procedures for patients. In the course of treatment, the tip preferably should be configured to address the special needs of geriatric or pediatric patients due to the delicate nature of their respective skin tissues.

There are several well-known procedures or techniques for “manipulating” or administering impulsive thrusts to a spine. One technique involves applying one or more thumb thrusts to misaligned or afflicted vertebrae. The ideal force/time wave form for an individual thumb thrust approximates a half-sine wave. As one will appreciate however, thumb thrusts initiated by a human tend to be both imprecise in magnitude and location and tiresome to administer. Another technique involves using a manually operated chiropractic-adjusting instrument. For instance, U.S. Pat. No. 4,116,235, issued to Fuhr et al., U.S. Pat. No. 6,702,836; issued to Fuhr et al., U.S. Pat. No. 6,379,375, issued to Fuhr et al., U.S. Pat. No. 5,626,615; issued to Keller et al., U.S. Pat. No. 5,656,017; issued to Keller et al., and U.S. Pat. No. 4,498,464, issued to Morgan, Jr., disclose such instruments.

Instrumented spinal manipulation, such as via the presently disclosed device has substantially overtaken the field of spinal manipulative therapy. Conventionally, these high velocity, low amplitude (HVLA) mechanical shockwave therapy devices are placed at the anatomic site of interest and triggered to deliver a force-time profile lower in amplitude, shorter in duration and with a faster force rate compared with a manually applied manipulation techniques. Throughout the years it has also been known that power driven mechanical shockwave therapy devices at times can offer benefits or advantages in use over the manually operated devices. Particularly, there is a current need for a compact, lightweight device that is portable and yet can be easily and repetitively apply a consistent desired impulse onto the patient via a tip at a desired location and direction without strength or fatigue issues compromising the treatment and without causing injury to the underlying skin tissue.

Electric solenoid operated adjusting instruments such as ones described in U.S. Pat. No. 4,841,955 issued to Evans, U.S. Pat. No. 4,682,490, issued to Adelman, U.S. Pat. No. 7,144,417 issued to Colloca, et al., or U.S. Pat. No. 8,083,699 issued to Colloca, et al. can provide adjusting and controllability benefits over manual devices. However, to date such electric solenoid operated adjusting instrument s have not been able to adequately reproduce the desired half sine wave form impulse.

### SUMMARY

The present chiropractic adjusting instrument system and method is capable of imparting desired energy impulses thereon a patient in the conduct of spinal manipulative therapy. To accomplish this, the invention provides a chiropractic adjusting instrument system and method that is configured to selectively apply desired impact forces or thrusts to a human body that can closely approximate the ideal half sine wave impulse configuration.

In one aspect, a portable chiropractic adjusting instrument, manipulator or thruster is provided that has an axially movable plunger having a resilient or cushioned thrust nose piece or tip that is mounted to a distal end of the plunger. A shockwave can thereby be applied to the geriatric or pediatric patient via a tip that should be designed to enhance the safety and efficacy of healthcare procedures for patients. This need should be addressed in the treatment of geriatric or pediatric patients due to the delicate nature of their respective skin tissues.

The present chiropractic adjusting instrument system and method allows for the transition from settings used for a normal adult to pediatric and/or geriatric settings. For pediatric and/or geriatric patients, an operator should consider anatomical differences, physiological characteristics, and the unique needs of the respective pediatric and/or geriatric patient. The tip described herein is configured to accommodate these specific requirements thereby allowing healthcare professionals to optimize the performance and usability of the chiropractic adjusting instrument system and method to improve patient outcomes in pediatric and geriatric care.

In one aspect, a proximal end portion of the plunger can be selectively placed into operative contact with a distal end of a selectively axially movable core of a solenoid so that energy exerted by the distal end of the core on the proximal end portion of the plunger can affect the application of a selectable adjustment energy impulse to a patient. In various aspects, it is contemplated that the chiropractic adjusting instrument system can be configured to be “tunable” or settable as to load, amplitude, and frequency within a selected range of natural frequency.

In one aspect, the chiropractic adjusting instrument system and method provides for the delivery of consistent and reproducible adjustments, which minimize variability between treatments and enhances patient comfort. Additionally, the chiropractic adjusting instrument system and method is configured for low-force application, which makes it suitable for patients of all ages, including pediatric and geriatric populations, and for other patient population who may be sensitive to manual manipulation techniques.

In a further aspect, the chiropractic adjusting instrument can have a self-contained power source which is long lasting and yet can be rechargeable or replaceable. It is contemplated that the power source can be an internal rechargeable battery or removable rechargeable battery pack. Optionally, the power source could be a conventional AC or DC power supply source.

Additional embodiments of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

These and other features of the preferred embodiments of the invention will become more apparent in the detailed description in which reference is made to the appended drawings wherein:

FIG. 1 is a perspective front side view of a chiropractic adjusting instrument.

FIG. 2 is a perspective rear side view of a chiropractic adjusting instrument.

FIG. 3 is a perspective read side view of the chiropractic adjusting instrument of FIG. 1, showing a rechargeable power source disconnected from a portion of a housing of the chiropractic adjusting instrument.

FIG. 4 is a perspective cross-sectional view of the chiropractic adjusting instrument of FIG. 1, showing an electromechanical drive assembly 50 mounted therein a housing of the chiropractic adjusting instrument.

FIG. 5 is partial cross-sectional view of the chiropractic adjusting instrument of FIG. 1.

FIG. 6 is a perspective side exploded view of chiropractic adjusting instrument of FIG. 1.

FIG. 7 is a schematic illustration of the electromechanical drive assembly and a preload travel limiter assembly in a rest position. In this example, the preload travel limiter assembly has an optional preload safety switch. Shown is a thrust tip plunger to an extended position and a base plate of the thrust tip plunger is contact with the first end of a thrust tip mount. Further shown is a hammer coupled to a solenoid rod of a solenoid that is spaced a maximal distance from the base plate of the thrust tip plunger.

FIG. 8 is a schematic illustration of the electromechanical drive assembly and the preload/safety assembly in a preload compressed position. Shown is a thrust tip plunger moved in a direction opposite to the actuation direction to a preload compressed position, which compresses an at least one bias element to a desired reload compressed level, and a base plate of the thrust tip plunger being in releaseable contact with a preload safety switch. Further shown is a hammer coupled to a solenoid rod of a solenoid that is spaced a distance less than the maximal distance from the base plate of the thrust tip plunger.

FIG. 9 is a schematic illustration of the electromechanical drive assembly and the preload/safety assembly upon actuation or energization of the solenoid subassembly and the resulting interaction of the solenoid subassembly with the trust tip subassembly, which results in the application of a controlled energy impulse to a patient via the tip portion of the trust tip subassembly. Shown is the solenoid being actuated to force the axial movement of the hammer of the solenoid subassembly into contact with the base plate of the thrust tip plunger to forcibly drive the base plate of the thrust tip plunger into contact with the first end of a thrust tip mount so that the tip portion of the thrust tip plunger is moved in the actuation direction back toward the extended position. Further shown is a base plate of the solenoid subassembly in contact with a back portion of the solenoid to limit the axis movement of the solenoid rod in the actuation direction.

FIG. 10 is a schematic illustration of the electromechanical drive assembly and a preload travel limiter assembly in a rest position. Shown is a mounting plate having an arm that extends outwardly from the surface of the mounting plate substantially in the actuation direction. In this aspect, the arm defines a distal end that is spaced a fixed predetermined distance from the surface of the mounting plate. Further shown is a hammer coupled to a solenoid rod of a solenoid that is spaced a maximal distance from the base plate of the thrust tip plunger. In this aspect, the distal end of the arm can be positioned to interfere with the rearward movement (opposite of the actuation direction) of the thrust tip plunger of the thrust tip assembly, e.g., the distal tip of the arm is configured to act as a stop by interfering with and contacting the base plate of the thrust tip plunger of the thrust tip assembly to limit the maximal rearward travel of the thrust tip plunger.

FIGS. 11-14 are graphical illustrations comparing actual energy thrust curves/impulses generated by the chiropractic adjusting instrument of FIG. 1 at various selected actuation levels compared to the idealized half-sine thrust wave forms. In the graphs, the dark line is the actual energy curve and the thinner line is the idealized half sine thrust wave form. As shown in the figures, the actual generated energy curve of the chiropractic adjusting instrument of FIG. 1 approximates a half-sine wave that is smooth, accelerates very fast, then slows down and stops. There is exhibited a smooth transition from an uphill portion of the curve to a complete stop and then to a downhill portion of the curve. It is contemplated that the separation of the hammer element of the solenoid subassembly from the back plate of the thrust tip plunger provides for a plurality of impulses to be applied to the patient upon a single actuation of the chiropractic adjusting instrument of FIG. 1 (the impulse as a result of the stored energy of the at least one bias element and the impulse as a result of the impact and drive of the hammer element upon the base plate of the thrust tip plunger).

FIG. 15 is a graphical illustration showing a representative shockwave force profile generated by the chiropractic adjusting instrument of FIG. 1 (e.g., that sold under the Activator V-E trademark) compared to an ideal half-sine wave spanning the same pulse width. As analyzed, the profile matched 96.41% that of the half-sine wave.

FIGS. 16A and 16B are graphical illustrations showing maximum thrust peak force for the four different mechanical shockwave devices against a stiff tissue analog and a soft tissue analog.

FIG. 17 is a graphical illustration showing peak output force of the chiropractic adjusting instruments sold under the Activator V-E and Impulse trademarks measured in hand-held operation and fixed frame operation against a stiff tissue analog and a soft tissue analog.

FIG. 18 is a graphical illustration showing plunger displacement for the four different mechanical shockwave devices against a stiff tissue analog and a soft tissue analog.

FIG. 19 illustrates a simplified, non-limiting block diagram showing select components of an exemplary operating environment for performing the disclosed methods.

FIG. 20 is a perspective front side view of different configurations for one embodiment of a rubber nose piece/tip portion configured for use with a chiropractic adjusting instrument to apply a desired impulse force thereon tissues of a geriatric and/or pediatric patient and showing the respective rubber nose piece/tip portions being formed from polyurethane rubber rods.

FIG. 21 is a cross-sectional view of one embodiment of a nose piece/tip portion configured for use with a chiropractic adjusting instrument to apply a desired impulse force thereon tissues of a geriatric and/or pediatric patient and showing a defined internal cavity within the rubber nose piece/tip portion that is in communication with the distal end of the thrust rod.

FIG. 22 is a cross-sectional view of one embodiment of a nose piece/tip portion configured for use with a chiropractic adjusting instrument to apply a desired impulse force thereon tissues of a geriatric and/or pediatric patient and showing a defined first internal cavity within the nose piece/tip portion that is in communication with the distal end of the thrust rod and a second internal infill cavity positioned between the distal end of the first internal cavity and the distal end of the nose piece/tip portion.

FIG. 23 is a top elevational view of different configurations for the infill member patterns suitable for insertion therein the second internal infill cavity of the nose piece/tip portion.

FIG. 24 is a perspective front side view of different configurations for one embodiment of a nose piece/tip portion configured for use with a chiropractic adjusting instrument to apply a desired impulse force thereon tissues of a geriatric and/or pediatric patient.

FIG. 25 is a perspective view of one embodiment of an experimental setup configured to test exemplary nose piece/tip portions that are configured for use with a chiropractic adjusting instrument to apply a desired impulse force thereon tissues of a geriatric and/or pediatric patient.

FIG. 26 is a graphical illustration showing peak output force generated with the chiropractic adjusting instrument (e.g., that sold under the Activator V-E trademark), over two respective power settings, for the respective nose piece/tip portions of FIG. 20 (in which the respective nose piece/tip portions are formed from rubber rods of differing compositions of polyurethane) and also comparatively showing the peak output force of the original rubber nose piece/tip portion provided with the chiropractic adjusting instrument of the present disclosure.

FIG. 27 is a graphical illustration showing comparative peak output forces generated with the chiropractic adjusting instrument (e.g., that sold under the Activator V-E trademark), over four respective power settings, for the original rubber nose piece/tip portion provided with the chiropractic adjusting instrument; for the original rubber nose piece/tip portion provided with the chiropractic adjusting instrument with an interposed member placed between the rubber nose piece/tip portion and the testing surface; for a nose piece/tip portion formed from a soft polymer; for a soft wide nose piece/tip portion formed from a soft silicone material, and for a soft narrow nose piece/tip portion formed from a soft silicone material.

FIG. 28 is a graphical illustration showing peak output force generated with the chiropractic adjusting instrument (e.g., that sold under the Activator V-E trademark), for the respective nose piece/tip portions of FIG. 22 (in which other infill member patterns as shown in FIG. 23 are disposed in the second internal infill cavity of the nose piece/tip portion) and also comparatively showing the peak output force of the original rubber nose piece/tip portion provided with the chiropractic adjusting instrument.

### DETAILED DESCRIPTION

The present invention may be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Thus, for example, reference to an “impulse setting” can include two or more such impulse settings unless the context indicates otherwise.

Ranges may be expressed herein as from “about” one particular value, and/or to “about” another particular value. Another aspect includes from the one particular value and/or to the other particular value in response to such a range being expressed. Similarly, the particular value forms another aspect in response to values being expressed as approximations by use of the antecedent “about.” It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The present invention may be understood more readily by reference to the following detailed description of preferred embodiments of the invention and the examples included therein and to the Figures and their previous and following description.

The present chiropractic adjusting instrument system and method is capable of imparting desired energy impulses thereon a patient in the conduct of spinal manipulative therapy. To accomplish this, the invention provides a chiropractic adjusting instrument system and method that is configured to selectively apply desired impact forces or thrusts to a human body that can closely approximate the ideal half sine wave impulse configuration.

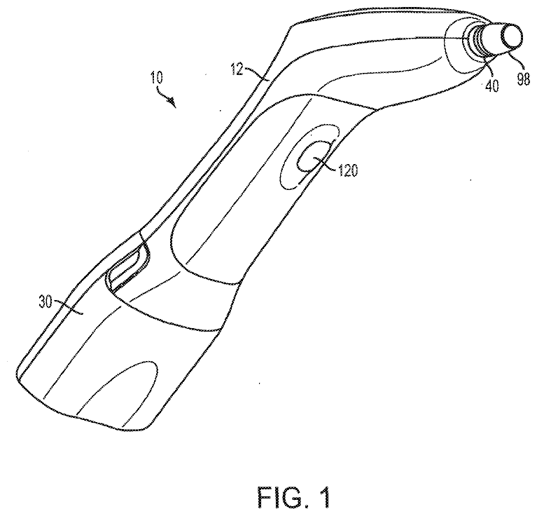

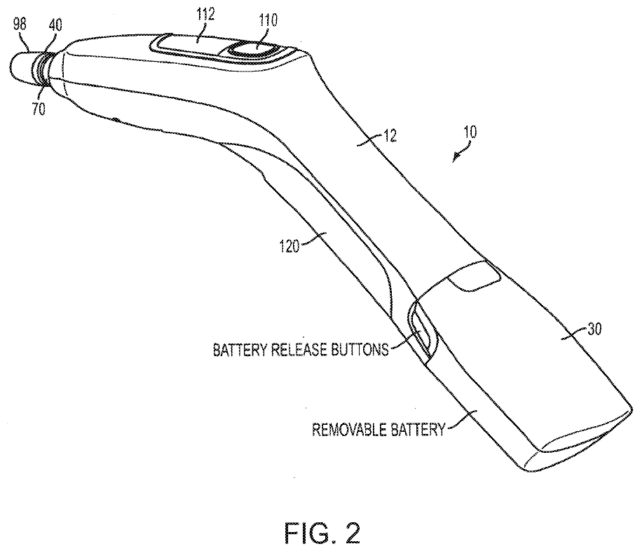

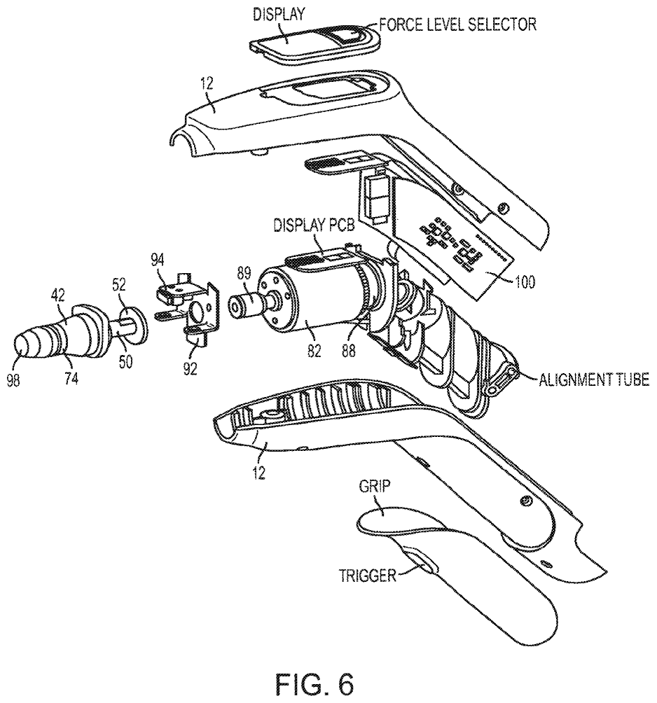

In one aspect, and referring now to FIGS. 1-6, a portable chiropractic adjusting instrument, manipulator or thruster 10 is provided that has an energy application assembly 20 that is mounted therein a housing 12. In one aspect, it is contemplated that the housing 12 can have an external shape that ergonomically allows for single handed grasping and operation of the chiropractic adjusting instrument. As shown, one contemplated shape of the housing is a gun shape. In one aspect, it is contemplated that the housing 12 can be formed from a non-conductive material such as, for example and without limitation, a polymer.

In a further aspect, the chiropractic adjusting instrument 10 can have a self-contained power source 30. In various aspects, it is contemplated that the self-contained power source can be long lasting and can be rechargeable and/or replaceable. For example, and without limitation, the power source 30 can be an internal rechargeable battery or a removable rechargeable battery pack. Optionally and not shown, it is contemplated that the housing can include a power cord that is configured to be conventionally coupled to an external conventional AC or DC power supply source.

In a further aspect, the housing 12 of the chiropractic adjusting instrument 10 can define a port 14 at one end of the housing and an interior cavity 16 for mounting an electromechanical drive assembly 35. In various aspects, the electromechanical drive assembly 35 can comprise a thrust tip subassembly 40 that is selectively coupled to a solenoid subassembly 80.

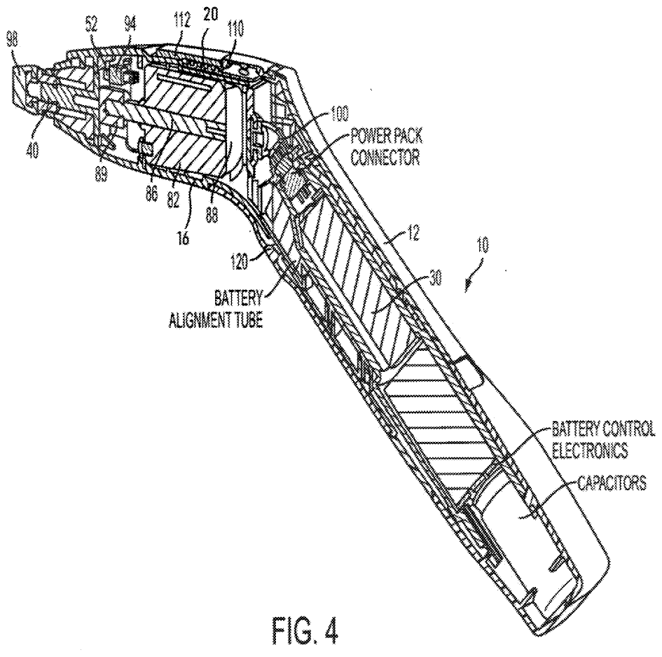

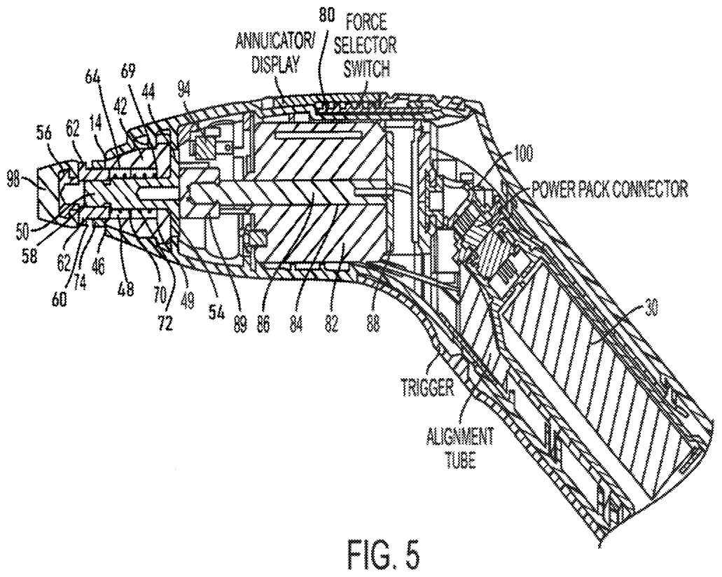

In one aspect, the thrust tip subassembly 40 can comprise a thrust tip mount 42, a thrust tip plunger 50, at least one bias element 70, and a resilient and/or cushioned nose piece 98. In one aspect, the thrust tip mount 42 has a substantially planar first end 44 and a spaced substantially planer second end 46. A core 48 is defined that extends along an elongate longitudinal axis of the thrust tip mount 42. In a further aspect, the core 48 has a first internal diameter proximate the first end of the thrust tip mount and a second, expanded internal diameter extending a predetermined distance from the second end toward the first end. As one will appreciate, a step 49 is defined at the transition in the core 48 from the first internal diameter to the enlarged second internal diameter. As shown in FIGS. 4 and 5, the thrust tip mount 42 can be positioned in the housing such that the second end 46 of the thrust tip mount 42 extends to the port 14 of the housing 12. In another aspect, it is contemplated that the second end 46 of the thrust tip mount can be positioned substantially co-planer to the walls of the housing 12 that define the port 14.

In another aspect, the thrust tip plunger 50 can comprise a substantially planar base plate 52, an elongate rod 54 and a tip 56. As shown in the figures, a proximal end of the elongate rod 54 is connected to and extends substantially transverse to the base plate 52. In one aspect, the rod 54 can have a cylindrical shape and have an outside diameter that is configured to be slideably received within the portion of the defined core 48 of the thrust tip mount 42 that is sized to the first internal diameter. In another aspect, the tip 56 of the thrust tip plunger 50 can have an end surface 58 that defines an internal cavity that is conventionally configured for the fixed coupling of the distal end of the rod 54. The external surface 60 of the tip proximate the end surface has a first outside diameter and has a shape that is configured to be slideably received therein the portion of the defined core 48 of the thrust tip mount 42 that is sized to the second internal diameter. In another aspect, at a predetermined distance from the end surface 58 of the tip 56, the external surface 60 of the tip defines a shoulder stop 62 as the external surface expands to an enlarged diameter.

As one skilled in the art will appreciate, the thrust tip plunger 50 is axially movable relative to the fixed thrust tip mount 42 about and between an extended position and a preload compressed position upon assembly. In the extended position, the tip 56 of the thrust tip plunger 50 is positioned a maximal axial distance from the first end 44 of the trust tip mount, the base plate 52 is in contact with first end 44 of the thrust tip mount 42 to constrain any further axial movement of the thrust tip plunger 50 in an actuation direction (which is co-axial to the longitudinal axis of the thrust tip mount 42), the end surface 58 of the tip 56 and a portion of the external surface 60 of the tip proximate the end surface are positioned therein the portion of the defined core 48 of the thrust tip mount 42 that is sized to the second internal diameter such that the end surface 58 is spaced at a maximal axial distance from the step 49 of the thrust tip mount 42, and the shoulder stop 62 of the tip 56 is positioned a maximal axial distance from the second end of the thrust tip mount 42. In the preload compressed position, the tip 56 of the thrust tip plunger is positioned at a reduced axial distance from the first end 44 of the trust tip mount, the base plate 52 is spaced at a predetermined distance from the first end of the thrust tip mount 42, the end surface of the tip 56 is spaced at a minimal axial distance from the step 49 of the thrust tip mount 42, and the shoulder stop 62 of the tip 56 is positioned a minimal axial distance from the second end of the thrust tip mount 42.

As shown in the figures, the portion of the core 48 having the expanded second internal diameter, a portion of the external surface of the rod 54 and the respective end surface 69 of the tip 56 and step 49 of the trust tip mount 42 define an internal cavity 64 that defines a volume that is maximal in the extended position and minimal in the preload compressed position. In one aspect, at least one bias element 70 is configured to resiliently urge the movement of the thrust tip plunger 50 to the extended position relative to the thrust tip mount 42. In one aspect, it is contemplated that the at least one bias element 70 can comprise a spring 72 that is positioned therein the internal cavity 64 and is interposed there between the respective end surface 69 of the tip 56 and step 49 of the trust tip mount 42. In various aspects, the spring 72 can be formed from a metallic material, a polymeric material, or combinations thereof, such as, for example and without limitation, ferrous metals including carbon steel, stainless steel, and spring steel; non-ferrous metals including beryllium copper, phosphor bronze, and titanium alloys; and polymers including polyurethane, silicone, and thermoplastic elastomers. In a further aspect, it is contemplated that the at least one bias element 70 can further comprise a conditioning ring 74 that is positioned thereon the external surface 60 of the tip 56 there between the respective shoulder stop 62 of the tip and the surface of the second end of the thrust tip mount 42. In various aspects, the conditioning ring 74 can be formed from a compressible material such as, for example and without limitation, elastomeric polymers including natural rubber, synthetic rubber, silicone rubber, polyurethane foam, ethylene propylene diene monomer (EPDM), and neoprene.

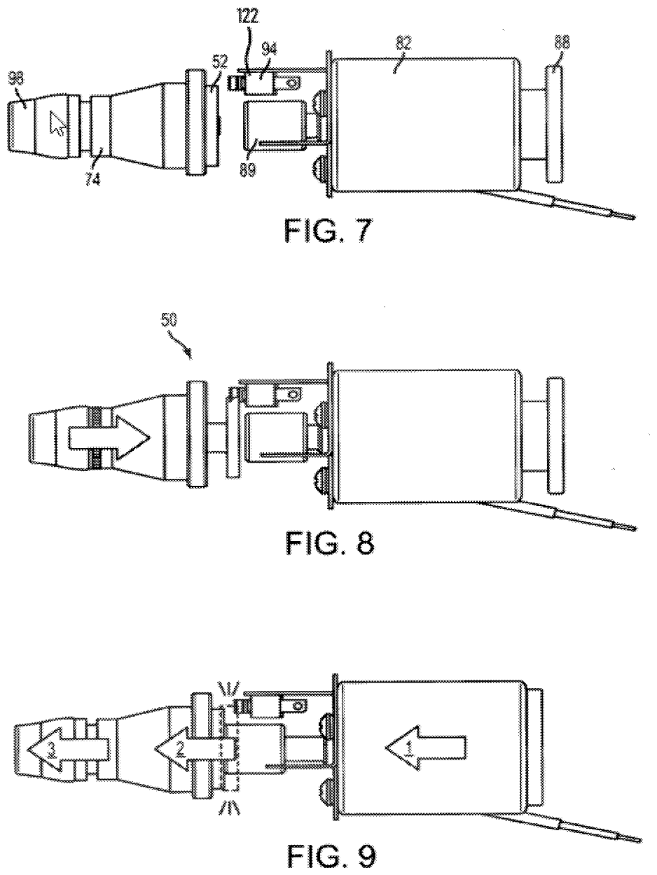

In operation and as shown in FIGS. 7-10, the spring 70 is maximally compressed there between the respective end surface 69 of the tip 56 and step 49 of the trust tip mount 42 in response to the thrust tip plunger 50 being moved to the compressed position, and, if used, the conditioning ring 74 is maximally compressed there between the respective shoulder stop 62 of the tip and the surface of the second end of the thrust tip mount 42. As one skilled in the art will appreciate, the spring force provided by the at least on bias element 70 is a constant based upon the construct of the at least one bias element and the distance that the at least one bias element is compressed to reach the fixed compressed position.

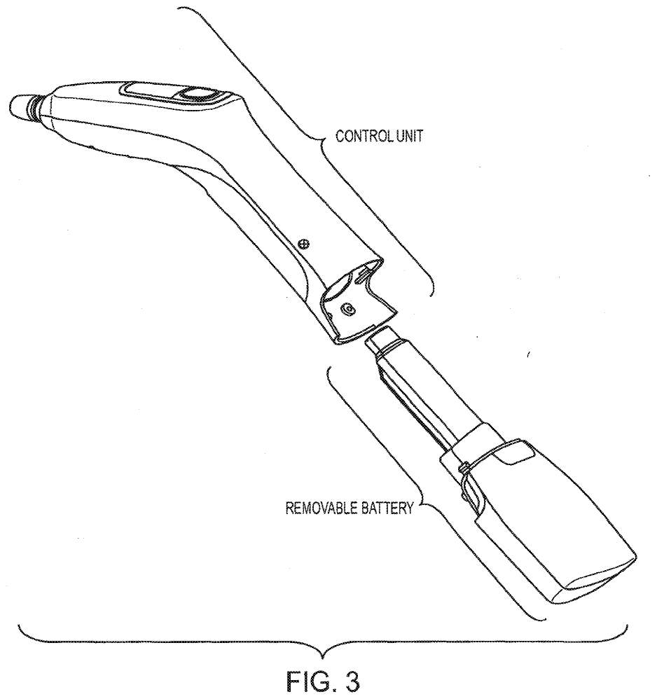

In a further aspect, the solenoid subassembly 80 can comprise a conventional solenoid 82 that defines a core 84 and that has a solenoid rod 86 that is selectively and conventionally biaxially movable therein the core 84 along a longitudinal axis of the solenoid in response to selective application or energization by a current supplied by the power source. In one aspect, it is contemplated that the longitudinal axis of the solenoid 82 is co-axial to the longitudinal axis of the thrust tip mount (collectively the “operational axis”) and the actuation direction of the chiropractic adjusting instrument. As shown, the solenoid 82 is mounted inside the housing 12 in a stationary position such that the solenoid rod 86 is selectively axially movable along the longitudinal axis and along the actuation direction. In another aspect, the solenoid subassembly 80 can also comprise a back plate 88 that is connected to the proximal end of the solenoid rod 86 and acts to limit the axial movement of the solenoid rod 86 in the actuation direction upon actuation of the solenoid. As shown in FIG. 3, the back plate is in contact with the back portion of the solenoid when the solenoid rod 86 reaches its maximal extended position upon actuation. In one aspect, the solenoid subassembly can further comprise a hammer element 89 that is coupled to the distal end of the solenoid rod 86.

In operation and as shown in FIGS. 7-8 and 10, the hammer element 89 is spaced from the base plate 52 at a maximal distance in response to the chiropractic adjusting instrument being at rest. The spacing between the hammer element 89 and the base plate 52 is reduced to a minimal distance as the thrust tip plunger of the thrust tip assembly is moved axially to the preload compressed position in a direction opposite to the actuation direction. However, it is noteworthy that in the preload compressed position, the hammer element 89 is spaced from the base plate 52 at a predetermined distance and is not in contact with the base plate 52. The hammer element 89 is placed into contact with the base plate 52 to drive the thrust tip plunger of the thrust tip assembly along the actuation direction to the extended position only upon actuation of the solenoid subassembly 80 and the subsequent constrained movement of the solenoid rod 86.

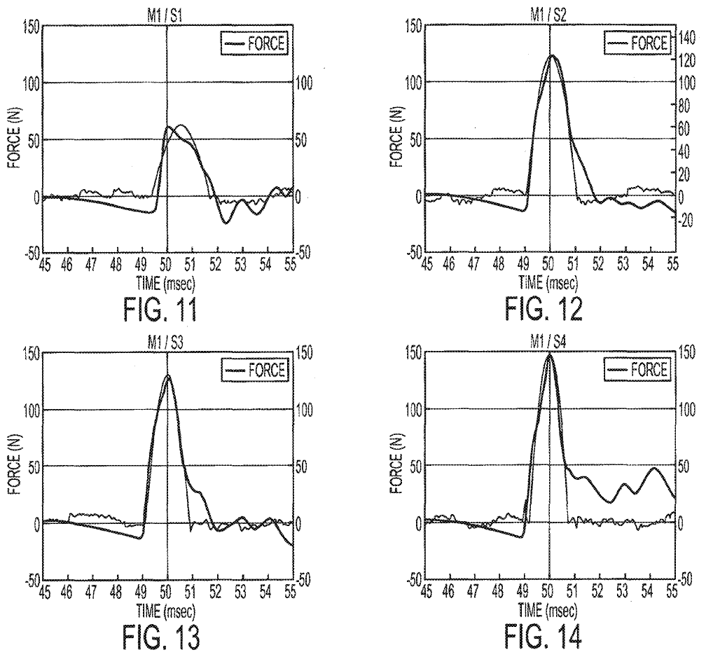

As one skilled in the art will appreciate, the force applied by the electromechanical drive assembly 50 is an additive force that comprised the substantially constant force applied by the at least one bias element 70 and the variable and selective force that can be applied to the thrust tip plunger of the thrust tip assembly via the hammer element of the solenoid at a result of the selective application of energy to the solenoid. As shown in FIGS. 11-15, the actual generated energy curve of the chiropractic adjusting instrument approximates closely a half-sine wave that is smooth, accelerates very fast, then slows down and stops. There is exhibited a smooth transition from an uphill portion of the curve to a complete stop and then to a downhill portion of the curve. It is contemplated that the separation of the hammer element of the solenoid subassembly from the back plate of the thrust tip plunger provides for a plurality of impulses to be applied to the patient upon a single actuation of the chiropractic adjusting instrument. It is further contemplated that the additive force is a combination of the impulse that is a result of the stored energy of the at least one bias element and the impulse that is the result of the impact and drive of the hammer element upon the base plate of the thrust tip plunger.

In a further aspect, and referring to FIGS. 7-10, the chiropractic adjusting instrument 10 can comprise a preload travel limiter assembly 90 that can have a mounting plate 92 and, optionally, a preload/safety switch 94. In one aspect the mounting plate can be mounted therein the housing 12 and can be positioned at or adjacent to the solenoid 82. The mounting plate can also have an arm 96 that extends outwardly from the surface of the mounting plate substantially in the actuation direction. In one aspect, the arm 96 can extend substantially parallel to the operational axis. In this aspect, the arm 96 can define a distal end 97 that is spaced a fixed predetermined distance from the surface of the mounting plate. In this aspect, the distal end 97 of the arm can be positioned to interfere with the rearward movement (opposite of the actuation direction) of the thrust tip plunger of the thrust tip assembly, e.g., the distal tip 97 of the arm is configured to act as a stop by interfering with and contacting the base plate of the thrust tip plunger of the thrust tip assembly to limit the maximal rearward travel of the thrust tip plunger. Further, in the described aspect, the distal end 97 of the arm 96 is configured such that hammer element 89 is spaced from the base plate 52 of the thrust tip plunger at a predetermined distance and is not in contact with the base plate 52 when the thrust tip plunger is compressed to the preload compressed position.

Optionally, the preload/safety switch 94 can be mounted to a distal portion of the arm 96 and can be configured to selectively releasably couple to the base plate 52 of the thrust tip plunger 50 in response to the thrust tip plunger being compressed to the preload compressed position. One will appreciate that the preload term refers to the stored mechanical energy provided by the compression of the at least one bias element 70. Further, and as shown in FIG. 8, the preload/safety switch 94 is mounted on the arm 96 such that hammer element 89 is spaced from the base plate 52 at a predetermined distance and is not in contact with the base plate 52 in response to the thrust tip plunger being compressed to the preload compressed position. Optionally, the mounting plate 92 can be configured to act at a mount for the solenoid and can define an opening that is suitably sized and shaped for the solenoid rod to be able to move axially without impediment.

In yet another aspect, the chiropractic adjusting instrument 10 can comprise a control electronic assembly 100 that is operable connected to the power source 30 to provide current, such as a direct current or an alternating current, to the solenoid 82 to impart impulse energy from the solenoid rod 86 and the coupled hammer element 89 to the thrust tip plunger 50 and hence to the resilient or cushioned nose piece 98 that is coupled to the tip distal most portion of the thrust tip plunger. As one will appreciate, the application of current to the solenoid 82 is controlled by the control electronic assembly 100 so that the applied energy impulse to the patient is reproducible.

In the preferred embodiment of the invention, the control electronic assembly 100 comprises at least a computational control circuit 102 and a storage device 104. In one aspect, it is contemplated that the computational control circuit 102 can utilize a microprocessor or any other comparable processing device to conduct mathematical processing for adjusting power supplied to the solenoid 82 to achieve the power outputted by the actuated solenoid rod.

The present methods and systems can be operational with numerous other general purpose or special purpose computing system environments or configurations. Examples of well-known computing systems, environments, and/or configurations that can be suitable for use with the system and method comprise, but are not limited to, personal computers, server computers, laptop devices, hand-held electronic devices, vehicle-embedded electronic devices, and multiprocessor systems. Additional examples comprise set top boxes, programmable consumer electronics, network PCs, minicomputers, mainframe computers, distributed computing environments that comprise any of the above systems or devices, and the like.

In one aspect, it is contemplated that the system and methods disclosed herein can be used in a single remote or a multiprocessor and/or distributed computing environment. In this aspect, the system and method can be adapted to receive data signals, such as, for example and without limitation, force levels applied to the patient via the resilient or cushioned nose piece 98 that is coupled to the tip distal most portion of the thrust tip plunger, the magnitude and/or duration of the force levels applied to the patient via the resilient or cushioned nose piece 98, and the like. In a further aspect, upon receipt of the data signals, the system and method can provide a means for displaying the data to the physician operator and can, in a further aspect, allow for the transmission of the desired processed data to the patient. In various aspect, as generally described below, it is contemplated that the transmission of the data to the physician operator and/or the patient can be done wirelessly via conventional wireless transfer technology to conventional display devices such as electronically coupled personal computers, server computers, laptop devices, hand-held electronic devices, vehicle-embedded electronic devices, and multiprocessor systems.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. In one aspect, the program modules can comprise a system control module. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein with respect to the at least a computational control circuit 102 and the storage device 104 of the control electronic assembly 100 can be implemented via a general-purpose computing device in the form of a computer 200. As schematically illustrated in FIG. 19, the components of the computer 200 can comprise, but are not limited to, one or more processors or processing units 203, a system memory 212, and a system bus 213 that couples various system components including the processor 203 to the system memory 212.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 213, and all buses specified in this description can also be implemented over a wired or wireless network connection and each of the subsystems, including the processor 203, a mass storage device 204, an operating system 205, contact sensor software 206, contact sensor data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computer 200 typically comprises a variety of computer readable media. Exemplary readable media can be any available media that is accessible by the computer 200 and comprises, for example and not meant to be limiting, both volatile and non-volatile media, removable and non-removable media. The system memory 212 can comprise computer readable media in the form of volatile memory, such as, for example and without limitation, random access memory (RAM), and/or non-volatile memory, such as, for example and without limitation, read only memory (ROM). The system memory 212 can provide storage for various computational equations, mathematical constants, power management and solenoid operational software, timers, counters and information regarding various desired impulse types and levels, and the specific operational requirements which are used by the computational control circuit during processing and operation. The system memory can also contain data such as pressure, magnitude, acceleration, and/or strike duration data 207 and/or program modules such as operating system 205 and output module software 206 that are immediately accessible to and/or are presently operated on by the processing unit 203. In one exemplary aspect, the system memory can also contain data such as the output of the chiropractic adjusting instrument 10 over a predetermined period or duration of time, which, as described in more detail below, can comprise be obtained from at least one transducer or a plurality of transducers that are coupled to and configured to measure force and acceleration of the thrust tip plunger 50.

In another aspect, the computer 200 can also comprise other removable/non-removable, volatile/non-volatile computer storage media. By way of example, FIG. 19 illustrates a mass storage device 204 which can provide non-volatile storage of computer code, computer readable instructions, data structures, program modules, and other data for the computer 200. For example, and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and contact sensor module software 206. Each of the operating system 205 and contact sensor module software 206 (or some combination thereof) can comprise elements of the programming and the load cell module software 206. Pressure and/or hysteresis data 207 can also be stored on the mass storage device 204. Pressure and/or hysteresis data 207 can be stored in any of one or more databases known in the art. Examples of such databases comprise relational database management systems (e.g., that sold under the DB2 trademark), desktop database applications (e.g., that sold under the Microsoft Access trademark), enterprise database systems (e.g., that sold under the Microsoft SQL Server trademark and the Oracle trademark), open-source database systems such as mySQL and PostgreSQL, and the like. The databases can be centralized or distributed across multiple systems.

In another aspect, in various embodiments, commands and information can be entered into the chiropractic adjusting instrument 10 via an input device. Examples of such input devices comprise, but are not limited to, inputs on the chiropractic adjusting instrument 10, a keyboard, pointing device (e.g., a “mouse”), a microphone, a joystick, a scanner, tactile input devices such as gloves, and other body coverings, and the like. These and other input devices can be connected to the processing unit 203 via a human machine interface 202 that is coupled to the system bus 213 but can be connected by other interface and bus structures, such as a parallel port, game port, an IEEE 1394 Port (also known as a high-speed serial communication port, e.g., that sold under the Firewire trademark), a serial port, or a universal serial bus (USB).

In yet another aspect, a display device 211 can also be connected to the system bus 213 via an interface, such as a display adapter 209. It is contemplated that the computer 200 can have more than one display adapter 209 and the computer 200 can have more than one display device 211. For example, a display device can be the indicator 112, a monitor, an LCD (Liquid Crystal Display), a projector, and the like. In addition to the display device 211, other output peripheral devices can comprise components such as a printer (not shown) which can be connected to the computer 200 via Input/Output Interface 210.

The computer 200 can operate in a networked environment using logical connections to one or more remote computing devices 214a,b,c. By way of example, a remote computing device can be a personal computer, portable computer, a server, a router, a network computer, a peer device or other common network node, and so on. Logical connections between the computer 200 and a remote computing device 214a,b,c can be made via a local area network (LAN) and a general wide area network (WAN). Such network connections can be through a network adapter 208. A network adapter 208 can be implemented in both wired and wireless environments. Such networking environments are conventional and commonplace in offices, enterprise-wide computer networks, intranets, and the Internet 215.

For purposes of illustration, application programs and other executable program components such as the operating system 205 are illustrated herein as discrete blocks, although it is recognized that such programs and components reside at various times in different storage components of the computing device 200 and are executed by the data processor(s) of the computer. An implementation of contact sensor software 206 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

In various aspects, it is contemplated that the methods and systems described herein can employ artificial intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

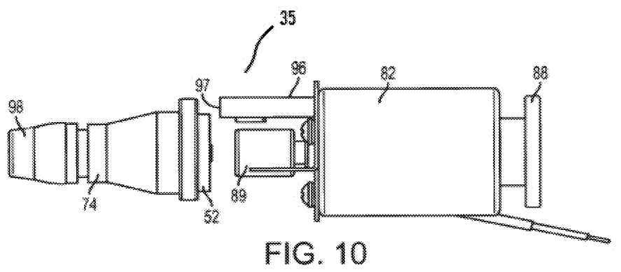

In one aspect, the computational control circuit 102 can be configured to diagnose/analyze the voltage and the frequency of the supplied current and can control the on-off duration of the application of the current to the solenoid to thereby energize the solenoid reproducibly so that the energy impulse supplied to the patient via the resilient or cushioned nose piece of the chiropractic actuator can produces a pulse duration or impulse of a desired wave form. More particularly, the energy impulse can substantially conform to the desired half sine wave shape. As further shown in FIGS. 10-13, graphs of actual energy impulses is plotted with a model of the desired high sine wave shape for four varied energy impulses. It is noteworthy that the energy impulses generated by the chiropractic adjusting instrument 10 of the present invention substantially mirror the desired or ideal model half sine wave shapes. In various aspects, the actual energy impulse substantially mirror or conforms to at least 90% of the desired wave shape; preferably to at least 93% of the desired wave shape, and still more preferably to at least 95% of the desired wave shape. It is also noteworthy that the shape confirmation between the actual energy impulse and the desired half sine impulse waveform is especially conforming in the first half of the actual energy impulse.

In an optional aspect, the computational control circuit 102 can be programmed to diagnose the chiropractic adjusting instrument 10 statuses; for example, whether or not the thrust tip plunger is in the preload compressed position and is releasably coupled to the preload/safety switch.

In various aspects, the control electronic assembly 100 can further comprise a level selector switch 110 positioned on the exterior of the housing and having a plurality of selectable positions for controlling the frequency and/or amplitude of the applied energy impulse. In another aspect, the control electronic assembly 100 can also comprise an annunciator or indicator 112 that is coupled to the computational control circuit to provide operator indications, which can exemplarily include, without limitation, power-on indication, preload ready indication, impulse level indication, and error indication. In one example, the indicator 112 can comprise a LED display mounted to the housing 12.

In a further aspect, the computational control circuit 102 can be configured to measure the output of the chiropractic adjusting instrument 10 over a predetermined period or duration of time. In various aspects, means for measuring the output can comprise at least one transducer or a plurality of transducers that are coupled to and configured to measure force and acceleration of the thrust tip plunger 50. In yet another aspect, means for measuring the output can comprise an accelerometer. Such an accelerometer can generate the desired acceleration signal. In this aspect, it is contemplated that the accelerometer can be a conventional accelerometer, such as, for example and without limitation, a piezo type accelerometer, MEMS type accelerometer, and the like. In one aspect, the means for measuring the output of the chiropractic adjusting instrument 10 can be coupled to the distal end of the thrust tip plunger 50.

In one aspect, force and acceleration signals generated by the at least one transducer can be analyzed to determine the impedance of the thrust tip plunger 50 during and immediately after activation. Further, it is contemplated that the force and acceleration signals generated by the at least one transducer can be analyzed to generate other applicable physical parameters. For example, and without limitation, the acceleration signal can be time integrated to obtain velocity of the thrust tip plunger 50 and then time integrated again to obtain displacement of the thrust tip plunger 50. For example, and without limitation, the ratio of force divided by displacement represents dynamic stiffness of the chiropractic adjusting instrument 10 and the patient. As one skilled in the art will appreciate, other combinations of these force and acceleration signals and resultant parameters can represent different physical means.

In one aspect, the chiropractic adjusting instrument 10 described herein operates on the principle of delivering precise mechanical impulses to targeted areas of the spine or joints, with the goal of restoring proper alignment, function, and mobility while minimizing discomfort and risk. The described chiropractic adjusting instrument 10 has the ability to deliver consistent and reproducible adjustments, which in turn provides for minimizing variability between treatments and enhancing patient comfort. It is desirable to be able to provide additional operator selectable low-force application levels that would allow the chiropractic adjusting instrument 10 to be used for pediatric and geriatric populations and for those who may be sensitive to manual manipulation techniques.

As described herein, the chiropractic adjusting instrument 10 can include the control electronic assembly 100 that is operable connected to the power source 30 to provide current, such as a direct current or an alternating current, to the solenoid 82 to impart impulse energy from the solenoid rod 86 and the coupled hammer element 89 to the thrust tip plunger 50 and hence to the resilient or cushioned nose piece/tip 98 that is coupled to the tip distal most portion of the thrust tip plunger. As one will appreciate, the application of current to the solenoid 82 is controlled by the control electronic assembly 100 so that the applied energy impulse to the patient is reproducible.

In embodiments, the chiropractic adjusting instrument 10 described herein uses a hammer-anvil concept for generating a mechanical shockwave. In summary, an electromagnetic solenoid accelerates a plunger that then strikes the internal tip assembly, thereby generating a forward momentum of the thrust tip plunger 50 and hence to the resilient or cushioned nose piece/tip 98. The nose piece/98 then pushes against the skin and is then decelerated due to the compliance of the underlying tissue. As further described herein, the deceleration of the nose piece/tip 98 momentum generates the typical half-sine thrust force over a duration of a few milliseconds. Therefore, the peak thrust force applied by the chiropractic adjusting instrument 10 is a combination of generated momentum by the device and compliance of the biological tissue. The fundamental engineering behind the working principal is conservation of momentum, which can be expressed as:

Σmivi=Σmivi′

Where mi represent the involved masses and vi represent the respective velocities prior and vi′ the velocities after the thrust. The principal of conservation of momentum states that the total momentum of a system remains constant when the net external force is zero. Thus, momentum is neither created nor destroyed, but only changed through the action of forces. Momentum is defined to be the mass of an object multiplied by the velocity of the object. The conservation of momentum further states that, within some problem domain, the amount of momentum remains constant; momentum is neither created nor destroyed, but only changed through the action of forces as described by Newton's laws of motion. One skilled in the art will appreciate that operating with momentum is more difficult than dealing with mass and energy because momentum is a vector quantity having both a magnitude and a direction.

As tabularly shown below, the nominal forces applied to the adult spine during chiropractic treatment typically ranges from between about 50 to about 300 Newton, more particularly between about 90 to about 250 Newton, and still more particularly between about 95 to about 241 Newton, which corresponds to between about 11 to about 67 pounds-force (about 50 to about 300 N), more particularly between about 20 to about 56 pounds-force (about 90 to about 250 N), and still more particularly between about 21 to about 54 pounds-force (about 95 to about 241 N). For operative use with pediatric and geriatric populations and for those who may be sensitive to manual manipulation techniques, it is desirable to be able to produce peak thrust force associated a lower end power setting of the chiropractic adjusting instrument 10, such as a chiropractic adjusting instrument (e.g., that sold under the Activator V-E trademark), to a peak thrust force applied by the nose piece/tip 98 of the device that is preferably at or below about 50 Newton (about 11 pounds-force), more preferably at or below about 40 Newton (about 9 pounds-force), still more preferably at or below 30 Newton (about 7 pounds-force), and particularly at or below about 20 Newton (about 4.5 pounds-force).

| Power | Peak Force | COV |
|---|---|---|
| Setting | [Newton] | [percent] |
| S1 | 95 | 9.9 |
| S2 | 201 | 3.5 |
| S3 | 217 | 2.3 |
| S4 | 241 | 1.3 |

In an embodiment, it is desirable to achieve the goal of selectively reducing the applied peak thrust forces applied by the nose piece/tip 98 of the device by altering the nose piece/tip 98 functionality without altering the functionality of the chiropractic adjusting instrument 10, such as a chiropractic adjusting instrument (e.g., that sold under the Activator V-E trademark). As indicated above, the chiropractic adjusting instrument 10 makes use of the conservation of momentum principle to generate the thrust force the patient experiences. As shown in the equations below, one skilled in the art will appreciate that this applied momentum can be expressed in terms of mass times velocity. Further, force can be expressed as mass times acceleration, consistent with Newton's second law of motion. Consequently, the thrust force is a product of the acceleration associated with change in momentum over the thrust duration. Thus, with the initial momentum of the device being constant, manipulation of the target momentum involves changing the thrust curve altogether.

$$Momentum = mass * velocity ; and \\ Force = mass * acceleration .$$

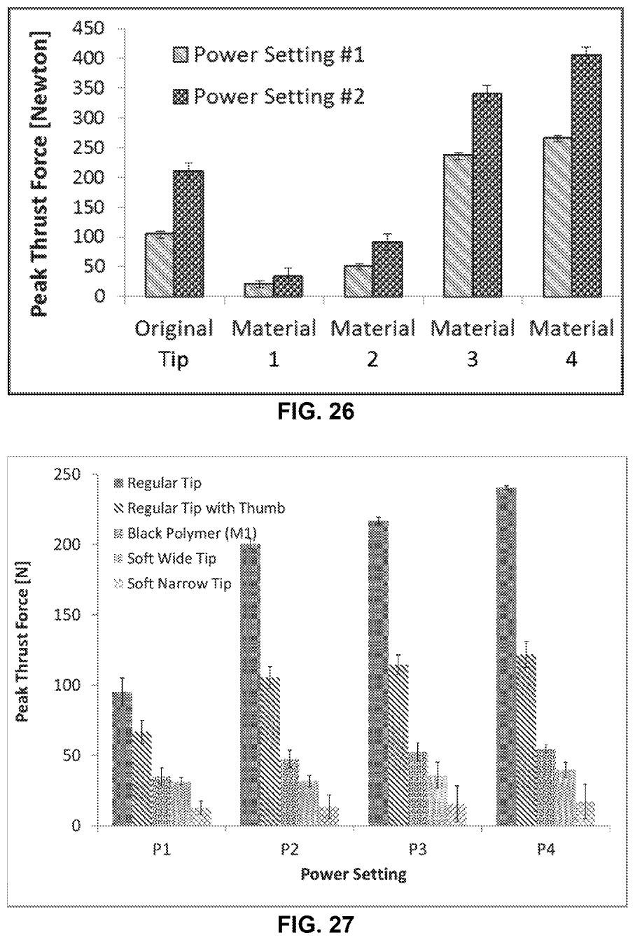

For pediatric and/or geriatric applications, it is expected to achieve more compliance of the biological tissue due to limited calcification of the hard tissue in pediatric patients and potential osteoporotic conditions in geriatric patients. Studies have shown that displacement of the nose piece/tip 98 should also desirably be limited due to anatomic size limitations, particularly in pediatric patients where vertebral bodies and spinous processes are significantly smaller than in adults. Initial studies that adjusted only the compliance of the thrust pathway with integration of soft material showed some success in limiting the applied peak thrust force. However, further studies have shown that this concept would also lengthen the thrust duration, thereby possibly limiting the therapeutic effects of the mechanical shockwave by shifting the driving frequency away from the tissue eigenfrequency and reducing shockwave penetration depth. For example, compliant polymers with an extended tip length (in the exemplary and not limiting form shown in FIG. 20 of four differing polyurethane rubber rods) were demonstrably able to achieve the desired reduction in applied peak thrust force applied by the nose piece/tip 98 of the device. FIG. 26 is a graphical illustration showing peak output force generated with the chiropractic adjusting instrument (e.g., that sold under the Activator V-E trademark), over two respective power settings, for the respective nose piece/tip shown in FIG. 20 (in which the respective rubber nose piece/tip portions are formed from rubber rods of differing compositions of polyurethane) and also comparatively showing the peak output force of the original nose piece/tip 98 that was provided with the chiropractic adjusting instrument.

Further studies indicated that the goal of achieving relatively low peak thrust values can be achieved by replacing the original rubber nose piece/tip that was provided with the chiropractic adjusting instrument (e.g., that sold under the Activator V-E trademark) with a nose piece/tip 98 formed from softer materials such as, for example and without limitation, elastomeric materials including silicone rubber, thermoplastic elastomers (TPE), thermoplastic polyurethane (TPU), and ethylene-vinyl acetate (EVA); foam materials including polyurethane foam, silicone foam, and cross-linked polyethylene foam; and other soft polymeric materials, and/or by varying the design of the nose piece/tip 98. In various embodiments, the elongate body of the nose piece/tip 98 can be formed from materials having a Shore A hardness ranging from about 5 to about 90, more particularly from about 10 to about 80, and still more particularly from about 10 to about 40, with softer materials (Shore A 10-40) being particularly suitable for pediatric and geriatric applications. The result of several such studies are shown in FIG. 27, which is a graphical illustration showing comparative peak output forces generated with the chiropractic adjusting instrument (e.g., that sold under the Activator V-E trademark), over four respective power settings, for the original rubber nose piece/tip 98 provided with the chiropractic adjusting instrument; for the original rubber nose piece/tip 98 provided with the chiropractic adjusting instrument with an interposed member placed between the rubber nose piece/tip 98 and the testing surface; for a nose piece/tip 98 formed from a soft polymer; for a soft, wide nose piece/tip 98 formed from a soft silicone material; and for a soft, narrow nose piece/tip 98 formed from a soft silicone material.

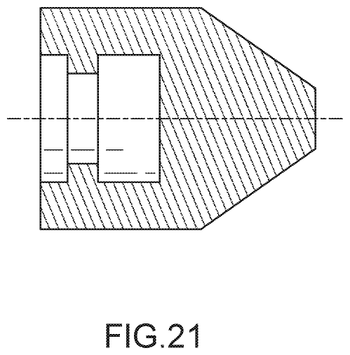

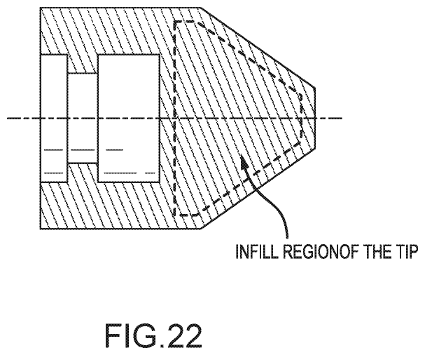

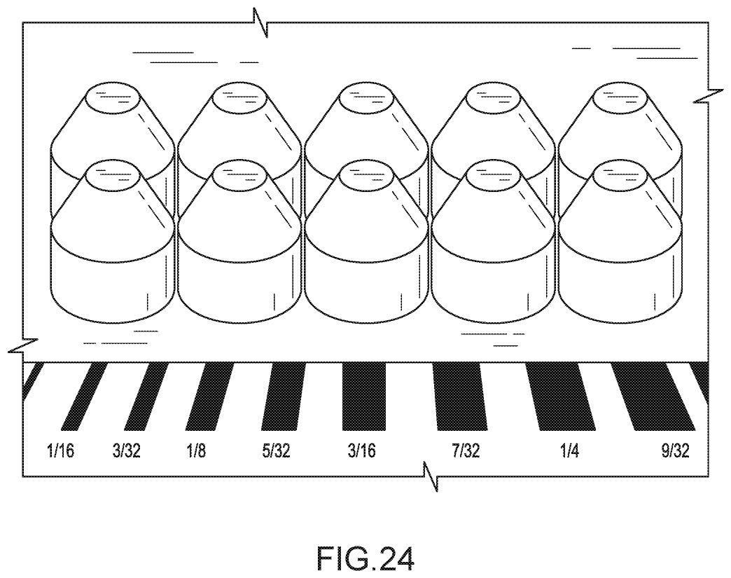

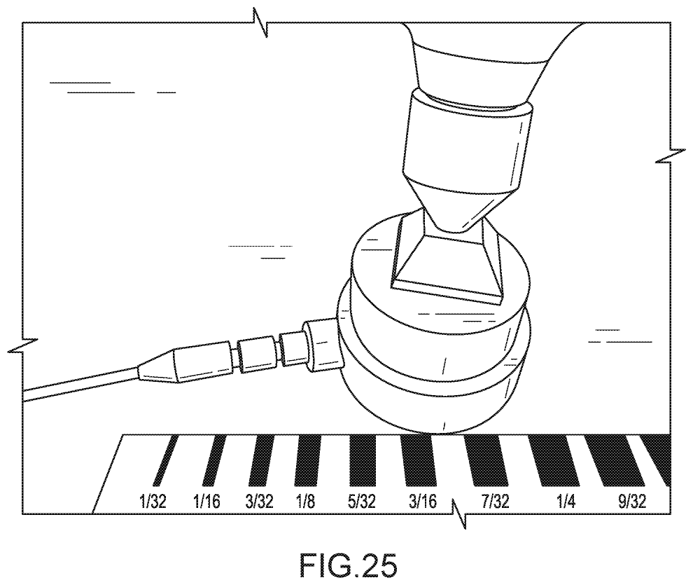

In various embodiments, and referring to FIGS. 21 to 24, a nose piece/tip 98 is shown. FIG. 21 shows a cross-sectional view of one embodiment of a nose piece/tip portion configured for use with a chiropractic adjusting instrument 10 such as the exemplary chiropractic adjusting instrument (e.g., that sold under the Activator V-E trademark) to apply a desired impulse force thereon tissues of a geriatric and/or pediatric patient. As shown in FIGS. 21 and 22, the nose piece/tip portion can be configured to define an internal cavity within the nose piece/tip portion that is in communication with the distal end of the thrust rod. This embodiment of the nose piece/tip portion can be formed with similar mounting design features associated with the original rubber nose piece/tip portion for attaching the tip to the chiropractic adjusting instrument. In operation, compared to the original rubber nose piece/tip 98 provided with the chiropractic adjusting instrument, the embodiment illustrated in FIGS. 21 and 22 has an elongate length that is greater than the original rubber nose piece/tip 98 provided with the chiropractic adjusting instrument and is provided with a distal end contact area that is less than (narrower) than the comparative original rubber nose piece/tip 98 provided with the chiropractic adjusting instrument.

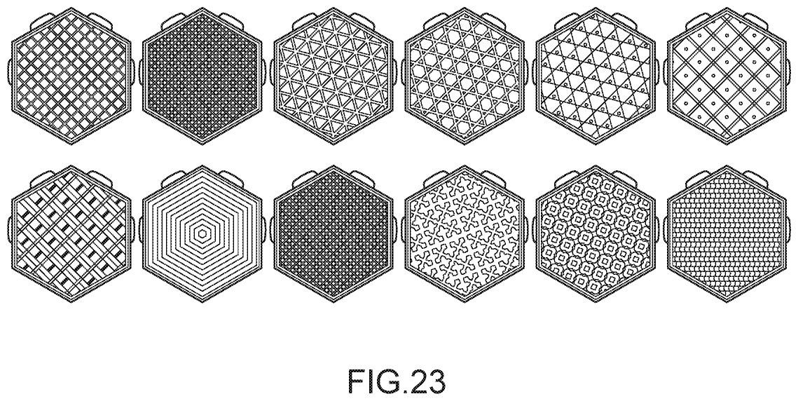

In another embodiment shown in FIG. 22, the nose piece/tip 98 portion is illustrated in cross-section. As shown, the nose piece/tip 98 portion is configured for use with a chiropractic adjusting instrument, such as the exemplary chiropractic adjusting instrument (e.g., that sold under the Activator V-Etrademark), to apply a desired impulse force thereon tissues of a geriatric and/or pediatric patient and showing a defined first internal cavity within the nose piece/tip portion that is in communication with the distal end of the thrust rod and a second internal infill cavity positioned between the distal end of the first internal cavity and the distal end of the nose piece/tip portion. The first internal cavity serves as the mounting interface that receives and couples to the thrust rod of the chiropractic adjusting instrument, providing a secure mechanical connection for force transmission. The second internal infill cavity provides a defined space for receiving an infill member with a selected micro-architecture. In this embodiment, it is contemplated that select infill members, such as the infill member patterns exemplarily shown, without limitation, in FIG. 23, can be mounted within or inserted therein the second internal infill cavity of the nose piece/tip portion. The infill member can be integrally formed with the elongate body during manufacture, or can be separately manufactured and subsequently inserted or bonded into the second internal infill cavity, thereby allowing for interchangeable infill members with different micro-architectures to be used with the same elongate body.

In various embodiments, the nose piece/tip 98 portion design shown in FIGS. 22 and 23 allow for at least the following functionality. First, the nose piece/tip 98 design can increase the in-line compliance of the chiropractic adjusting instrument, which is particularly beneficial for pediatric and geriatric patients whose tissues exhibit different mechanical properties than adult tissues. Specifically, increased compliance allows the nose piece/tip 98 to absorb and distribute the initial impact energy over a longer displacement, thereby reducing the instantaneous force transmitted to the patient's skin and underlying structures. Second, the nose piece/tip 98 design can restrict the thrust duration to maintain the therapeutic half-sine waveform characteristics necessary for effective mechanical shockwave therapy, preventing the prolonged thrust durations that would otherwise result from using highly compliant materials alone. Third, the nose piece/tip 98 design can establish a force safety threshold that operates as an inherent mechanical limit on peak force transmission, providing a passive safety mechanism that protects vulnerable patient populations from excessive force application regardless of device power settings.

The desired improved functionality results from the design features of the nose piece/tip 98 portion design shown in FIGS. 22 and 23, which allows for the insertion of an infill member with a selected micro-architecture into the second internal infill cavity of the nose piece/tip portion to adjust the volume fraction of the front portion of the nose piece/tip 98 portion. The micro-architecture of the infill member comprises a three-dimensional structural pattern that defines the mechanical response characteristics of the nose piece/tip 98. By selecting specific infill member patterns, the practitioner can tune the force-displacement relationship of the nose piece/tip 98 to match the demands of different patient populations and treatment protocols. This embodiment allows for a significant increase in the flexibility of the front portion of the nose piece/tip 98 portion upon reducing the internal printed volume fraction to between about 5 and about 30 percent, more particularly between about 10 and about 20 percent, and still more particularly between about 12 and about 18 percent, meaning the internal volume is occupied by printed material by the stated percentage, with the remaining volume being air. In various embodiments, the volume fraction can be adjusted to achieve different force-compliance characteristics suitable for specific applications. This functionality permits limiting the peak thrust force through the controlled deformation of the micro-architecture and incorporates buckling behavior of the micro-architecture to limit thrust duration while maintaining the therapeutic half-sine waveform profile.

In embodiments and in operation, the initial elasticity of the nose piece/tip 98 portion design shown in FIGS. 22 and 23 provides resistance to the compression force of the chiropractic adjusting instrument, such as the exemplary chiropractic adjusting instrument (e.g., that sold under the Activator V-E trademark), against the skin of the patient. The micro-architecture of the infill member exhibits an initial elastic regime wherein the structural elements of the infill pattern deform reversibly under applied load, providing a predictable and repeatable force-displacement response. During this elastic regime, the nose piece/tip 98 stores mechanical energy while transmitting the therapeutic impulse to the patient. The internal architecture of the nose piece/tip 98 portion starts to buckle in response to the peak force being achieved, which allows for the controlled loss of the integrity and stability of the nose piece/tip 98 portion. The buckling phenomenon represents a transition from elastic deformation to a controlled structural collapse of the micro-architecture elements, wherein the structural members of the infill pattern undergo lateral displacement and fold upon themselves. In operation, the buckling feature allows for rapid reduction in force and at the same time allowing for further compression with minimal resistance. This non-linear force-displacement behavior creates a force plateau or force ceiling effect that limits the maximum force that can be transmitted through the nose piece/tip 98 to the patient. Consequently, the buckling feature operatively limits the thrust duration while at the same time providing a non-linear means to protect the patient from peak forces that could be too high, thereby establishing an inherent force safety threshold that operates independently of the device power settings.

In various embodiments, the infill member can be formed from elastic materials including, without limitation, elastomeric polymers such as thermoplastic polyurethane (TPU), thermoplastic elastomers (TPE), silicone rubber, natural rubber, and synthetic rubbers including styrene-butadiene rubber (SBR) and ethylene propylene diene monomer (EPDM); thermoplastic materials such as flexible polyamides (nylon), polylactic acid (PLA), polyethylene terephthalate glycol (PETG), and acrylonitrile butadiene styrene (ABS); and combinations thereof. The selection of infill member material can be based on the desired mechanical properties including elastic modulus, yield strength, and fatigue resistance. In preferred embodiments, the infill member material exhibits an elastic modulus between about 1 MPa to about 1000 MPa (about 145 psi to about 145,000 psi), more particularly between about 5 MPa to about 500 MPa (about 725 psi to about 72,500 psi), and still more particularly between about 10 MPa to about 200 MPa (about 1,450 psi to about 29,000 psi), allowing for appropriate deformation characteristics during the thrust cycle. The infill member can be manufactured using additive manufacturing techniques such as fused deposition modeling (FDM), stereolithography (SLA), selective laser sintering (SLS), or can be formed through injection molding, compression molding, or other conventional polymer processing methods.

The micro-architecture of the infill member can be characterized by several geometric parameters that influence the force-displacement behavior of the nose piece/tip 98. These parameters include the infill pattern type, the infill density (expressed as volume fraction), the wall thickness (number of perimeter layers), the layer height, and the orientation of the infill pattern relative to the direction of force application. By varying these parameters, the force response characteristics of the nose piece/tip 98 can be tuned to achieve specific peak force values, thrust duration profiles, and buckling thresholds. For example, a honeycomb infill pattern provides high strength-to-weight ratio and predictable buckling behavior, while a gyroid infill pattern provides isotropic mechanical properties and gradual force buildup. Rectilinear and line patterns provide directional compliance characteristics that can be oriented to optimize force transmission along the thrust axis. The selection of infill pattern and parameters enables customization of the nose piece/tip 98 for specific patient populations and treatment protocols.

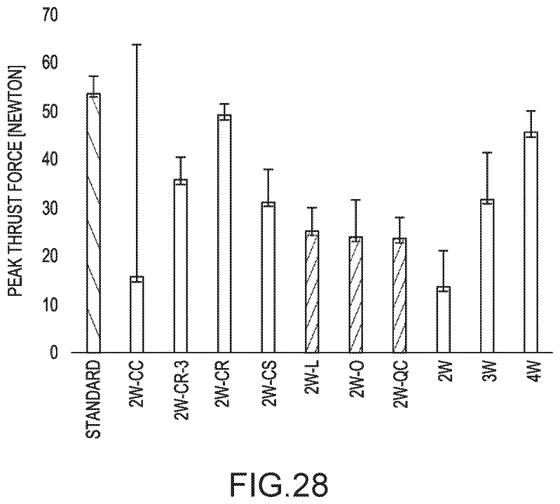

In further embodiments and referring now to FIG. 28 in which peak output force generated with the chiropractic adjusting instrument (e.g., that sold under the Activator V-E trademark) for the respective nose piece/tip portions of FIG. 22 is graphically illustrated. As graphically illustrated, peak output force generated with the chiropractic adjusting instrument for other infill member patterns as shown in FIG. 23 that are disposed in the second internal infill cavity of the nose piece/tip portion are demonstrated. Further, peak output force of the original rubber nose piece/tip portion provided with the chiropractic adjusting instrument are comparatively shown.

As experimentally demonstrated, the elasticity of the infill material allows for repeatability and durability. Experimental testing indicated a wide variance in the measured peak thrust force by keeping the volume fraction of the infill constant while varying the pattern of the infill member, demonstrating that the geometric configuration of the micro-architecture, not merely the volume fraction, significantly influences the force transmission characteristics. Aside from one infill member pattern (2 W-CC), the coefficient of variance was less than 10% for any design, indicating that the disclosed nose piece/tip 98 designs provide consistent and reproducible force output suitable for clinical applications Three of the 10 evaluated infill member patterns were selected for further evaluation based on their force reduction performance and repeatability characteristics. The designs varied by the different infill pattern while keeping the infill density at 10%. Three additional designs included no infill patterns and varied by changing the number of wall layers, ranging from 2 to 4, demonstrating that wall thickness provides another mechanism for tuning the mechanical response. In various embodiments, infill member patterns can include, without limitation, honeycomb, gyroid, rectilinear, triangular, cubic, concentric, line, cross, and grid patterns, each providing different force-displacement characteristics based on their geometric properties. The performance of nose piece/tip portions was tested using one OEM chiropractic adjusting instrument (e.g., that sold under the Activator V-E trademark) in hand-held operation, pressing the pediatric tip against a tissue analog representing the tissue elastic modulus of pediatric patients, and measuring the resulting thrust curve using an impact sensor at a sampling rate of 26,000 samples per second. A total of ten nose piece/tip portions per design were tested and for each tip between 5 and 6 thrusts were captured per testing cycle, providing statistically significant data for evaluating the consistency and performance of each design.

In embodiments suitable for pediatric applications, the nose piece/tip 98 is configured to address the unique anatomical and physiological characteristics of pediatric patients. Pediatric patients typically exhibit higher tissue compliance due to lower bone density and calcification, smaller vertebral dimensions, and more delicate skin and subcutaneous tissues. Accordingly, the nose piece/tip 98 for pediatric applications can be configured with an infill member having a volume fraction between about 1 and about 25 percent, more particularly between about 5 and about 15 percent, and still more particularly between about 8 and about 12 percent, resulting in peak thrust forces preferably at or below about 50 Newton (about 11 pounds-force), more preferably at or below about 30 Newton (about 7 pounds-force), and still more preferably at or below about 15 Newton (about 3.4 pounds-force). The elongate body of the pediatric nose piece/tip 98 can have a reduced distal end contact area, such as between about 0.08 inches to about 0.5 inches (about 2 mm to about 12 mm) in diameter, more particularly between about 0.12 inches to about 0.31 inches (about 3 mm to about 8 mm) in diameter, and still more particularly between about 0.16 inches to about 0.24 inches (about 4 mm to about 6 mm) in diameter, to accommodate the smaller anatomical structures of pediatric patients while maintaining appropriate pressure distribution. In operation, the pediatric nose piece/tip 98 provides sufficient compliance to prevent tissue damage while maintaining thrust durations between about 1 millisecond to about 15 milliseconds, more particularly between about 3 milliseconds to about 8 milliseconds, and still more particularly between about 4 milliseconds to about 6 milliseconds, to preserve the therapeutic half-sine waveform characteristics.

In embodiments suitable for geriatric applications, the nose piece/tip 98 is configured to address the unique anatomical and physiological characteristics of geriatric patients. Geriatric patients often exhibit reduced skin elasticity, thinner subcutaneous tissue layers, increased bone fragility due to osteoporosis, and potential presence of skin conditions that may increase susceptibility to tissue damage. Accordingly, the nose piece/tip 98 for geriatric applications can be configured with an infill member having a volume fraction between about 3 and about 30 percent, more particularly between about 8 and about 18 percent, and still more particularly between about 10 and about 15 percent, resulting in peak thrust forces preferably at or below about 60 Newton (about 13.5 pounds-force), more preferably at or below about 40 Newton (about 9 pounds-force), and still more preferably at or below about 25 Newton (about 5.6 pounds-force). The elongate body of the geriatric nose piece/tip 98 can have an increased distal end contact area, such as between about 0.2 inches to about 0.8 inches (about 5 mm to about 20 mm) in diameter, more particularly between about 0.31 inches to about 0.59 inches (about 8 mm to about 15 mm) in diameter, and still more particularly between about 0.39 inches to about 0.51 inches (about 10 mm to about 13 mm) in diameter, to distribute the applied force over a larger surface area and reduce localized pressure on fragile skin. In operation, the geriatric nose piece/tip 98 provides enhanced compliance characteristics that account for the altered tissue mechanical properties of elderly patients while maintaining the therapeutic efficacy of the mechanical shockwave treatment.

In another exemplary aspect, force output can be measured indirectly through the electric power applied to the solenoid. In this aspect, it is contemplated that the applied electric power can be described as the product of the electric current and the applied voltage or the product of the electric current squared times the electric resistance. In this aspect, the electric current can be measured by conventional means, such as, for example and without limitation, a current transducer, a small integrated resistor, and the like. Further, voltage can be measured by conventional means, such as, for example and without limitation, a large resistor, an integrated circuit (e.g., an operational amplifier wired as voltage follower) in parallel to the solenoid, and the like. It is contemplated that the computational control circuit 102 can be configured to correlate the measured electric power or electric current to values representing the solenoid output thrust force.

In one aspect, it is contemplated that the signal analysis can be performed by the computational control circuit 102 of the chiropractic adjusting instrument 10. The results of the signal analysis can be depicted on the indicator 112 as a feedback to the device operator. Optionally, it is contemplated that the results of the signal analysis or the generated signals can be conventionally transferred to an external console (not shown) and then depicted for use by the device operator. One person skilled in the art can optionally elect to depict the data as graphs, charts, figures, percentage, absolute values, and the like.

In one aspect, it is contemplated that the signal analysis and derived results can be used to assess the tissue response of the patient, which can be used to determine treatment need or current state of the health of the patient. In this aspect, a comparative analysis can be made between a pre-defined normal tissue state of the patient and the current measurements that reflect the current tissue state of the patient. Optionally, the comparative analysis can be made with comparison to other reference data, such as, for example and without limitation, the patient's own prior data, a pooled dataset from other patients and healthy individuals, reference charts, and the like. In another aspect, the determined signals, signal analysis, and/or derived results signals can be used to assess the tissue response of the patient before and after therapeutic intervention. It is contemplated that the determined differential measure can be used by one skilled in the art to determine therapeutic success or success of the medical intervention.

In one aspect, the chiropractic adjusting instrument 10 can comprise a triggering system 120 for triggering the electromechanical drive system via the control electronic assembly 100. In one aspect, the triggering system 120 can comprise, in various embodiments, a trigger and a trigger spring so the control electronic assembly can be selectively caused to direct the electromechanical drive assembly 35 to fire. In an optional aspect, the triggering system 120 can also comprise a trigger switch 122 that is activated by the preload/safety switch 94. The trigger switch 122 can be configured to act as an interlock or safety device such that the electromechanical drive assembly 35 cannot be actuated unless the preload/safety switch 94 is activated. In various aspects, the trigger switch 122 can be any type of conventional optical, electrical, mechanical or magnetic switch and may be configured in many ways such that it is coupled to the electromechanical drive assembly to prevent firing unless activated.

In one aspect, the portable chiropractic adjusting instrument for applying an adjustment energy impulse to a patient is described. In this aspect, the portable chiropractic adjusting instrument can comprise housing, a power source, a thrust tip subassembly, at least one bias element, and a solenoid subassembly. In one aspect, it is contemplated that the housing can define an interior cavity and a port. In another aspect, the power source can be a battery. Optionally, the battery can be a conventional rechargeable battery.

In one aspect, the thrust tip subassembly is mounted in the housing and can comprise a thrust tip plunger having a tip and a base plate that is coupled to and extends substantially transverse to an elongate rod that is configured to be slideably received within the housing. In this aspect, the thrust tip plunger can be configured to be axially movably relative to the housing about and between an extended position and a preload compressed position. Optionally, the thrust tip plunger can be configured to be axially movably relative to the thrust tip mount along the longitudinal axis of the thrust tip mount. In a further aspect, the at least one bias element can be configured to urge the thrust tip plunger in an actuation direction.

In a further aspect, the thrust tip subassembly can also comprise a thrust tip mount having a first end and a spaced second end and defining a core extending an elongate longitudinal axis of the thrust tip mount. In one aspect, the thrust tip mount can be positioned in the housing such that the second end of the thrust tip mount extends to the port. In another aspect, the rod of the thrust tip subassembly can be configured to be slideably received within a portion of the core of the thrust tip mount that is sized to a first internal diameter. Further, the external surface of the tip of the thrust tip subassembly can be configured to be slideably received therein a portion of the core of the thrust tip mount that is sized to a second internal diameter that is greater than the first internal diameter.

In another aspect, the solenoid subassembly can be selectively coupled to the power source and the thrust tip subassembly. In this aspect, it is contemplated that the solenoid subassembly can comprise a solenoid, a solenoid rod and a hammer element. In one aspect, the solenoid defines a core and the solenoid rod can be selectively and conventionally biaxially movable therein the core along a longitudinal axis of the solenoid, which can be co-axial with the longitudinal axis of the thrust tip mount. In this aspect, it is contemplated the solenoid rod is biaxially moveable in response to selective application and/or energization by a current supplied by the power source. In one aspect, the hammer element can be coupled to the solenoid rod and spaced from the base plate of the thrust tip plunger at or between a maximal distance when the thrust tip plunger is in the extended position and the solenoid in not activated and a minimal distance when the thrust tip plunger is in the extended position and the solenoid in not activated. In this aspect, the hammer element selectively forcefully contacts the thrust tip plunger in response to selective energization of the solenoid by the current supplied by the power source upon actuation.

In another aspect, the portable chiropractic adjusting instrument can further comprise a preload/safety switch that can be configured to releasably hold the thrust tip plunger of the thrust tip assembly in the preload compressed position. In this aspect, in the preload compressed position, the base plate of the thrust tip plunger is spaced from the hammer element of the solenoid subassembly.

In another aspect, the portable chiropractic adjusting instrument can further comprise an indicator. In a further aspect, the portable chiropractic adjusting instrument can further comprise means for changing the frequency or amplitude of the energy impulse applied to the patient and/or means for measuring the output of the device for a predetermined period of time. In one aspect, the means for measuring the output can comprise at least one transducer configured to measure force and acceleration of the thrust tip plunger. In a further aspect, the means for measuring the output further comprises a means for determining at least one of: the adjustment energy impulse applied to the patient by a distal end of the thrust tip plunger; the magnitude of the adjustment energy impulse applied to the patient by the distal end of the thrust tip plunger; and the magnitude of the adjustment energy impulse applied to the patient by the distal end of the thrust tip plunger over time. Further, it is contemplated that in operation, a portable chiropractic adjusting instrument as described and embodied above can be provided to the operator. Subsequently, by sequentially applying the tip of the thrust tip plunger to a desired location and orientation on the patient and actuating the portable chiropractic adjusting instrument, a desired an adjustment energy impulse can be administered to the patient.

In a further aspect, selective data can be displayed to the operator and the patient, on the patient's selected device, that is indicative of the applied adjustment energy impulse and the efficacy of the treatment protocol with the portable chiropractic adjusting instrument as described and embodied above. In this aspect, in use, the method for using the portable chiropractic adjusting instrument can providing the portable chiropractic adjusting instrument as described above; applying the tip of the thrust tip plunger to a desired location and orientation on the patient; actuating the portable chiropractic adjusting instrument; determining at least one treatment data protocol from at least one of: the adjustment energy impulse applied to the patient by a distal end of the thrust tip plunger; the magnitude of the adjustment energy impulse applied to the patient by the distal end of the thrust tip plunger; and the magnitude of the adjustment energy impulse applied to the patient by the distal end of the thrust tip plunger over time; and selectively displaying the at least one treatment protocol to the patient.

### Example

Four different mechanical shockwave devices were tested to determine the ability of the mechanical shockwave devices to achieve a desired thrust profile. Two of the mechanical shockwave devices were manually operated and exemplified the known spring loaded hammer type mechanical shockwave devices (chiropractic adjusting instruments sold under the Activator II and Activator IV/FS trademarks, from Activator Methods International Ltd., Phoenix, AZ), while the other two mechanical shockwave devices were electrically powered via an electromagnetic solenoid (a chiropractic adjusting instrument sold under the Impulse trademark from Neuromechanical Innovations LLC, Chandler, AZ), and the mechanical shockwave devices of the present invention (hereinafter referred to as the chiropractic adjusting instrument sold under the Activator V-E trademark from Activator Methods International Ltd., Phoenix, AZ).

All devices were tested in a standardized fashion: one component of the device housing was affixed to the testing frame through a machined screw-on collar. The collar prevented a relative motion of the device with respect to the test frame. In various embodiments, the rubber cap of the mechanical shockwave devices was removed and an impedance head attached was coupled in replacement. In various embodiments, the rubber cap was then replaced on the front of the impedance head. In various embodiments, the impedance head included a dynamic load cell and a tri-axial accelerometer.

In front of the device were, in various embodiments, homogeneous polymer blocks (tissue analogs) and a second dynamic load cell. The polymer blocks were affixed to the load cell, which was rigidly mounted to the frame. The polymer blocks represented ranges of human tissue compliance values that might be seen in the clinic plus additional extreme cases. During device application, the mechanical shock wave propagated from the release mechanism through the impedance head, the rubber cap, and the polymer blocks to the front plate of the resting dynamic load cell. The most compliant component within that line of action was, in various embodiments, the rubber cap, which was the commercial rubber cap used in the chiropractic adjusting instruments sold under the Activator II, IV/FS and V-E trademarks.

The chiropractic adjusting instruments sold under the Activator IV/FS and Activator V-E trademarks and the chiropractic adjusting instrument sold under the Impulse trademark were pre-loaded based on the manufacturer's recommendation. For the chiropractic adjusting instrument sold under the Activator II trademark, a pre-set gap distance between the device tip and the tissue analog was determined for each thrust magnitude setting and the device locked in that position.

After pre-loading, the chiropractic adjusting instruments sold under the Activator IV/FS and the Activator V-E trademarks were set to one of their four thrust settings. The four possible settings were selected in random fashion in order to eliminate systematic errors. The same procedure was repeated for the three possible settings of the chiropractic adjusting instrument sold under the Impulse trademark. For the chiropractic adjusting instrument sold under the Activator II trademark, a fraction of the full scale range was selected to represent intermediate values.

| Device | Device Settings | | Adjustment Ability |
|---|---|---|---|
| Activator II | Low | (2 revolutions) | Turning a |
| (Device #1) | Medium | (4 revolutions) | Knurled Nut |
| | Maximum | (7.5 revolutions) | |

| | | |
|---|---|---|
| Activator | 1 | Internal Device |
| IV/FS | 2 | Twisting |
| (Device #2) | 3 | Mechanism |
| | 4 | |
| Activator V-E | 1 | Thrust Selector |
| (Device #3, | 2 | Push Button, |
| Present | 3 | Electronic Switch |
| Invention) | 4 | |
| Impulse | 1-Low | Electronic |
| (Device #4) | 2-Medium | Toggle Switch |
| | 3-High | |

As the treatment effectiveness depends significantly on the mechanical shockwave to propagate into the body, it is desirable for the shockwave to come as close to a half-sine wave as possible. Vibration damping can be minimized if the shockwave is a pure half-sine wave at or near the eigenfrequency. The shockwave profile is characterized in terms of its crest factor and shape approximation of a half-sine wave, with the deviation expressed in percent. Several additional parameters were extracted and calculated from the recorded thrust output profiles of the four different devices. Mainly, the peak thrust force in pounds-force (Newtons), the peak thrust acceleration in feet/second² (Meters/Seconds²), the thrust duration or pulse width in milliseconds, the plunger displacement in inches (millimeters). The data were tabulated and the mean and standard deviation calculated for each series (N=10). This process was repeated for each device and setting.

Due to the similar profiles of the four mechanical shockwave device types, a fixed-effects statistical model comparison was performed. Major focus was placed on statistical comparison of the peak output force [pounds-force (Newton)], the force pulse duration [milliseconds], the plunger displacement during thrust execution [inches (millimeters)] and the thrust velocity [feet/second (meters/second)]. Since the similar power settings were utilized for all devices, a multi-factorial analysis of variance (ANOVA) for device type, pulse width, plunger travel and thrust velocity was performed on the mean values of those parameters for all devices. Paired two-tailed T-tests were conducted on the main effects and interactions between devices and parameters.

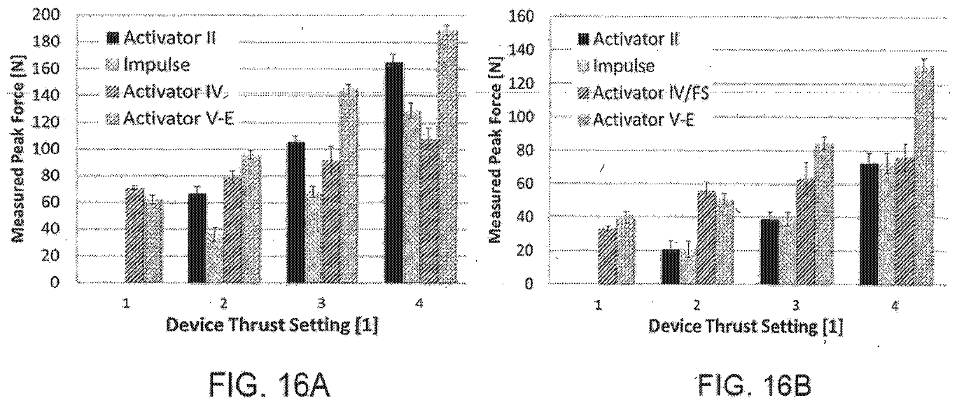

As shown in FIGS. 16A and 16B, all four tested mechanical shockwave devices were substantially equivalent in their thrust force output. Due to its four different settings, the chiropractic adjusting instrument sold under the Activator V-E trademark was able to span the largest variable range of thrust values. The device with the least range was the chiropractic adjusting instrument sold under the Activator IV/FS trademark. Although the chiropractic adjusting instrument sold under the Activator II trademark has an infinite number of adjustment capabilities between its maximum thrust and zero, only three settings were evaluated. The chiropractic adjusting instrument sold under the Impulse trademark achieved a range of thrust values between the Activator IV/FS and the Activator V-E devices. The overall thrust force comparison is depicted for all of the mechanical shockwave devices tested against the 258.07 N/mm (1,473 lbf/in) polymer block.

The shockwave profile differed significantly between the four tested mechanical shockwave devices and power settings. In general, the pulse width increased with increased compliance of the material and higher power settings. For most devices, the pulse width was between about 1 millisecond to about 10 milliseconds, more particularly between about 3 milliseconds to about 7 milliseconds, and still more particularly between about 4 milliseconds to about 6 milliseconds. The exception was the chiropractic adjusting instrument sold under the Activator II trademark, which had a pulse width of around 12 milliseconds. Considering this pulse width as part of a half-sine wave, the driving frequency of the Activator II device was around 42 Hz while for the remaining devices had a driving frequency between about 50 Hz to about 200 Hz, more particularly between about 72 Hz to about 150 Hz, and still more particularly between about 80 Hz to about 120 Hz.

| | Setting 1 | Setting 2 | Setting 3 | Setting 4 |
|---|---|---|---|---|
| Activator V-E | | | | |
| Pulse Width [msec] | 4.70 | 5.79 | 5.15 | 6.88 |
| Peak Force [N] | 62 | 96 | 145 | 189 |
| Velocity [m/sec] | 0.76 | 0.83 | 0.97 | 1.09 |
| Plunger Travel [mm] | 0.82 | 0.89 | 0.97 | 1.10 |
| Activator IV/FS | | | | |
| Pulse Width [msec] | 3.33 | 6.58 | 5.74 | 5.86 |
| Peak Force [N] | 71 | 79 | 92 | 108 |
| Velocity [m/sec] | 0.44 | 1.04 | 0.59 | 0.82 |
| Plunger Travel [mm] | 0.20 | 1.96 | 0.46 | 0.67 |
| Activator II | | | | |
| Pulse Width [msec] | 11.4 | 11.6 | 11.7 | |
| Peak Force [N] | 67 | 106 | 165 | |
| Velocity [m/sec] | 1.07 | 1.82 | 1.35 | |
| Plunger Travel [mm] | 1.99 | 2.96 | 3.19 | |
| Impulse | | | | |
| Pulse Width [msec] | 4.02 | 3.81 | 4.08 | |
| Peak Force [N] | 36 | 68 | 129 | |
| Velocity [m/sec] | 0.63 | 1.02 | 1.22 | |
| Plunger Travel [mm] | 0.93 | 1.0 | 1.24 | |

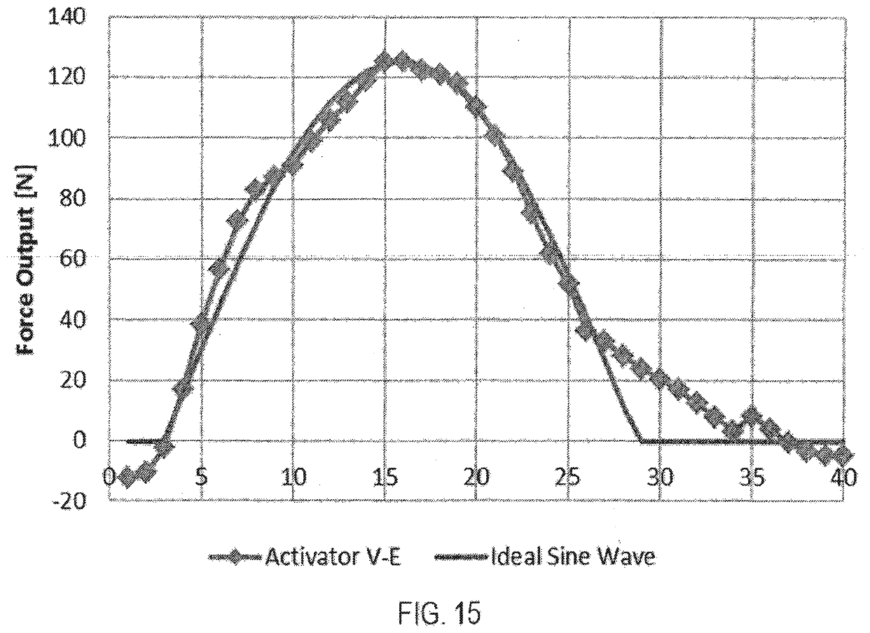

The approximation of a half-sine wave with the thrust curves was less achieved with the spring-loaded devices (chiropractic adjusting instruments sold under the Activator II and IV/FS trademarks) compared to the more programmable electromagnetically powered devices (chiropractic adjusting instruments sold under the Activator V-E and Impulse trademarks). On average, the Activator II device captures 48% (±6.1%) of the half-sine wave profile, the Activator IV/FS 74% (±8.3%), the Impulse 83% (±3.9%) and the Activator V-E 94% (±3.5%). This finding is also reflected in the Crest factor, which was 1.13=0.21 for the Activator II device, 1.28±0.16 for the Impulse device, 1.32±0.18 for the Activator IV/FS device, and 1.43±0.16 for the Activator V-E device. One skilled in the art will appreciate that a Crest factor of 1.4142 indicates a perfect half-sine wave. Referring to FIG. 15, in one exemplary test, the shockwave force profile of the chiropractic adjusting instrument sold under the Activator V-E trademark (the portable chiropractic adjusting instrument described herein) matched to within 96.41% of the ideal half-sine wave.

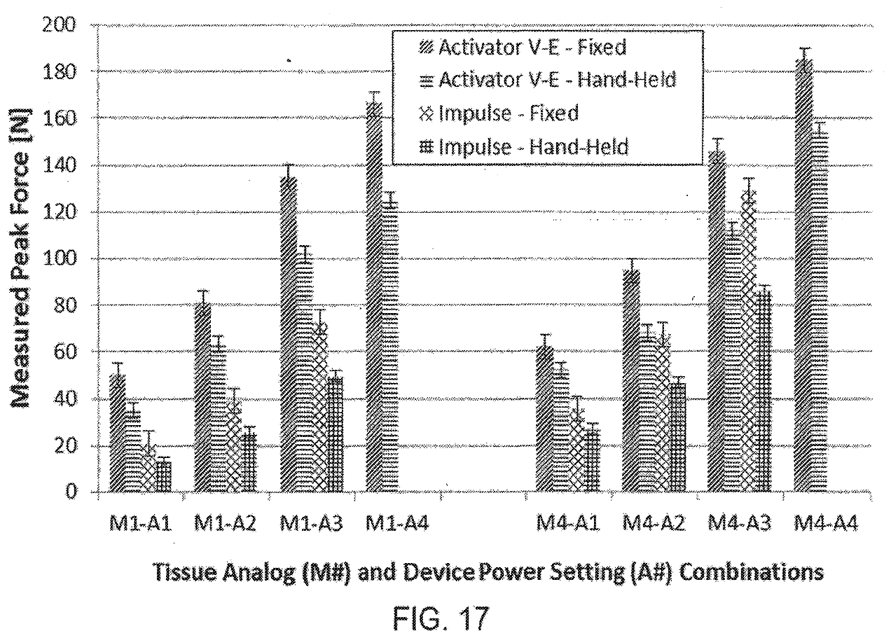

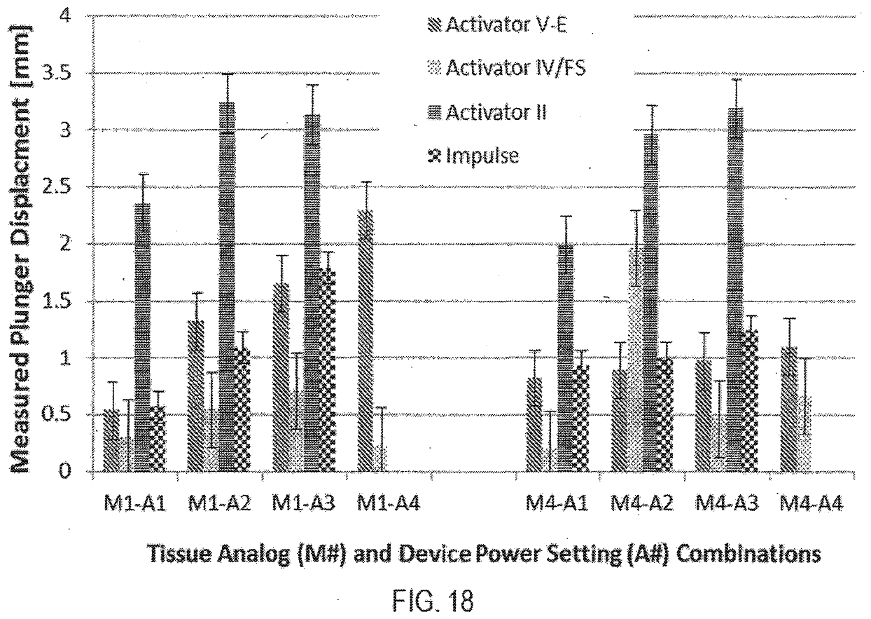

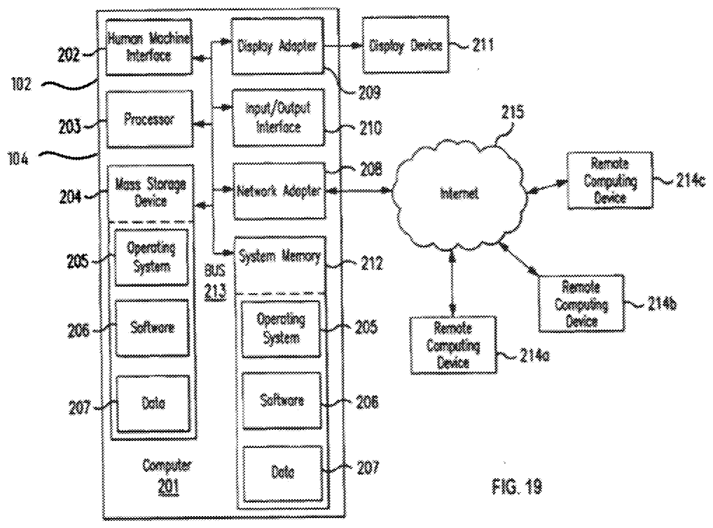

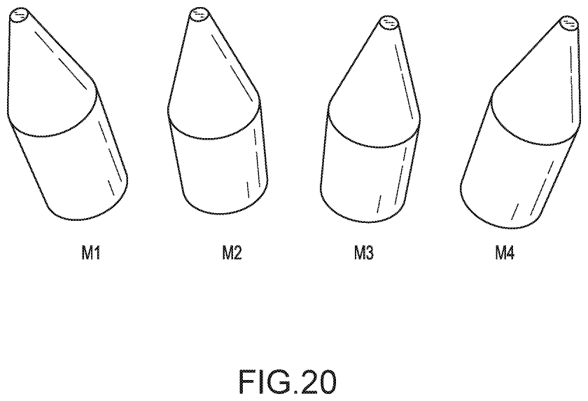

Similarly to pulse duration, the measured thrust velocity (maximum velocity of the plunger during the force generation phase) is less dependent on the compliance of the tissue analog than on the device power setting. As shown in FIG. 17, the more compliant tissue analog involved a larger deformation to generate the measured output force compared to the stiffer tissue analog. Since the pulse width is reasonably constant, a higher velocity is needed to deform a softer material compared to a stiffer one. Referring to FIG. 18, plunger displacement varied proportional with power settings for the stiff material but less so for the softer material. The exception was the chiropractic adjusting instrument sold under the Activator II trademark, which showed a strong correlation between power setting and plunger travel for both tissue analogs.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is therefore understood that the invention is not limited to the specific embodiments disclosed herein, and that many modifications and other embodiments of the invention are intended to be included within the scope of the invention. Moreover, although specific terms are employed herein, they are used only in a generic and descriptive sense, and not for the purposes of limiting the described invention.

What is claimed is:

1. A nose piece/tip portion for use with a chiropractic adjusting instrument to apply a desired impulse force thereon tissues of a geriatric and/or pediatric patient, comprising:
an elongate body defining a first internal cavity that is in communication with a distal end of a thrust rod of the chiropractic adjusting instrument and defining a second internal infill cavity positioned between the distal end of the first internal cavity and the distal end of the elongate body; and
an infill member having a select micro-architecture, mounted within the second internal infill cavity of the elongate body to adjust the volume fraction of a front portion of the elongate body.

2. The nose piece/tip portion of claim 1, wherein the infill member is configured to increase in-line compliance of the chiropractic adjusting instrument.

3. The nose piece/tip portion of claim 1, wherein the infill member is configured to restrict thrust duration of the chiropractic adjusting instrument.

4. The nose piece/tip portion of claim 1, wherein the infill member is configured to establish a force safety threshold.

5. The nose piece/tip portion of claim 1, wherein the select micro-architecture of the infill member adjusts the volume fraction of the front portion of the elongate body to between 10 and 20 percent.

6. The nose piece/tip portion of claim 1, wherein the infill member is configured to buckle in response to achieving a peak force to provide controlled loss of integrity and stability of the nose piece/tip portion.

7. The nose piece/tip portion of claim 6, wherein buckling of the infill member allows for rapid reduction in force while permitting further compression.

8. The nose piece/tip portion of claim 1, wherein the elongate body is formed from a resilient material.

9. The nose piece/tip portion of claim 8, wherein the resilient material comprises at least one elastomeric material including at least one of polyurethane, silicone rubber, thermoplastic elastomers or ethylene-vinyl acetate.

10. The nose piece/tip portion of claim 1, wherein the infill member is formed from an elastic material.

11. The nose piece/tip portion of claim 1, wherein the nose piece/tip portion is configured to produce a peak thrust force at or below about 11 pounds-force (about 50 Newton).

12. The nose piece/tip portion of claim 11, wherein the nose piece/tip portion is configured to produce a peak thrust force at or below about 7 pounds-force (about 30 Newton).

13. The nose piece/tip portion of claim 1, wherein the elongate body has a length greater than an original rubber nose piece/tip portion of the chiropractic adjusting instrument.

14. The nose piece/tip portion of claim 1, wherein the elongate body defines a distal end contact area that is narrower than a comparative original rubber nose piece/tip portion of the chiropractic adjusting instrument.

15. The nose piece/tip portion of claim 1, wherein the elongate body comprises mounting design features configured for fixed coupling to the chiropractic adjusting instrument.

16. The nose piece/tip portion of claim 1, wherein the select micro-architecture of the infill member comprises a pattern selected from a plurality of infill member patterns.

17. The nose piece/tip portion of claim 16, wherein the plurality of infill member patterns provide varying measured peak thrust forces while maintaining a substantially constant volume fraction.

18. The nose piece/tip portion of claim 1, wherein the infill member has a coefficient of variance of less than 10 percent for measured peak thrust force.

19. The nose piece/tip portion of claim 1, wherein the chiropractic adjusting instrument comprises an electromagnetic solenoid configured to accelerate a plunger that strikes an internal tip assembly to generate forward momentum of a thrust tip plunger.

20. A method of applying a desired impulse force to tissues of a geriatric and/or pediatric patient using a chiropractic adjusting instrument, the method comprising: providing a nose piece/tip portion comprising an elongate body defining a first internal cavity in communication with a distal end of a thrust rod of the chiropractic adjusting instrument, and a second internal infill cavity positioned between the distal end of the first internal cavity and the distal end of the elongate body, wherein an infill member having a select micro-architecture is mounted within the second internal infill cavity to adjust a volume fraction of a front portion of the elongate body; positioning the nose piece/tip portion against skin of the patient; and actuating the chiropractic adjusting instrument to deliver a mechanical impulse through the nose piece/tip portion to the patient, wherein the infill member limits peak thrust force applied to the patient.
